(19) United States
(12) Patent Application Publication
(10) Pub. No.: US 2017/0338618 A1
(43) Pub. Date: Nov. 23, 2017

(54) HIGH-VOLTAGE PULSE GENERATOR AND GAS LASER APPARATUS

(71) Applicants: National University Corporation Nagaoka University of Technology, Niigata (JP); Gigaphoton Inc., Tochigi (JP)

(72) Inventors: Weihua JIANG, Nagaoka-shi (JP); Hiroshi UMEDA, Oyama-shi (JP); Hakaru MIZOGUCHI, Oyama-shi (JP); Takashi MATSUNAGA, Oyama-shi (JP); Hiroaki TSUSHIMA, Oyama-shi (JP); Tomoyuki OHKUBO, Oyama-shi (JP)

(73) Assignees: National University Corporation Nagaoka University of Technology, Niigata (JP); Gigaphoton Inc., Tochigi (JP)

(21) Appl. No.: 15/671,572

(22) Filed: Aug. 8, 2017

Related U.S. Application Data
(63) Continuation of application No. PCT/JP2016/058564, filed on Mar. 17, 2016.

(30) Foreign Application Priority Data
Mar. 25, 2015 (JP) PCT/JP2015/059106

(51) Int. Cl. H01S 3/097; H01S 3/038; H01S 3/225; H01S 3/041; H01S 3/036

(52) U.S. Cl. CPC H01S 3/09702; H01S 3/225; H01S 3/041; H01S 3/038; H01S 3/036

(57) ABSTRACT

A high-voltage pulse generator may include a number “n” (n is a natural number of not less than 2) of primary electric circuits connected in parallel to one another on the primary side of a pulse transformer, and a secondary electric circuit of the pulse transformer, which is connected to a pair of discharge electrodes disposed in a laser chamber of a gas laser apparatus. The “n” primary electric circuits may include a number “n” of primary coils connected in parallel to one another, a number “n” of capacitors respectively connected in parallel to the “n” primary coils, and a number “n” of switches respectively connected in series to the “n” capacitors. The “n” primary electric circuits may be connected to a number “n” of chargers for charging the “n” capacitors, respectively. The secondary electric circuit may include a number “n” of secondary coils connected in series to one another, and a number “n” of diodes each connected to opposite ends of each of the “n” secondary coils, to prevent a reverse current flowing from the pair of discharge electrodes toward the secondary coils.

### CROSS-REFERENCE TO RELATED APPLICATIONS

This application is a continuation application of International Application No. PCT/JP2016/058564 filed on Mar. 17, 2016. The content of the application is incorporated herein by reference in its entirety.

### BACKGROUND

### 1. Technical Field

The disclosure relates to a high-voltage pulse generator and a gas laser apparatus.

### 2. Related Art

With miniaturization and high integration of a semiconductor integrated circuit, improvement of resolution is demanded in a semiconductor exposure apparatus (hereinafter, referred to as an “exposure apparatus”). Accordingly, the wavelength of light emitted from a light source for exposure is being shortened. As the light source for exposure, a gas laser apparatus is used in place of an existing mercury lamp. As a gas laser apparatus for exposure, a KrF excimer laser apparatus that emits ultraviolet rays of a wavelength of 248 nm and an ArF excimer laser apparatus that emits ultraviolet rays of a wavelength of 193 nm are currently employed.

As a current exposure technology, liquid immersion exposure has been used in practice, wherein a gap between a projection lens on an exposure apparatus side and a wafer is filled with a liquid to change the refractive index of the gap, thereby shortening the apparent/virtual wavelength of the light source for exposure. In the liquid immersion exposure using the ArF excimer laser apparatus as the light source for exposure, ultraviolet rays having a wavelength of 134 nm in water/liquid is applied to the wafer. This technology is called ArF liquid immersion exposure or ArF liquid immersion lithography.

Because the spectrum line width in natural oscillations of the KrF and ArF excimer laser apparatuses is so wide, about 350 pm to about 400 pm, that a color aberration occurs in the laser light (ultraviolet rays) as projected in a reduced size on the wafer through the projection lens on the exposure apparatus side, degrading the resolution. Therefore, it is necessary to narrow the spectrum line width of the laser light emitted from the gas laser apparatus such that the color aberration becomes ignorable. The spectrum line width is also called the spectrum width. Accordingly, a line narrowing module (LNM) having a line narrowing element is provided in a laser resonator of the gas laser apparatus, to achieve narrowing the spectrum width by the line narrowing module. Note that the line narrowing element may include an etalon, a grating and the like. The laser apparatus with a spectrum width narrowed in this way is called a narrowband laser apparatus.

### CITATIONS

### Patent Literatures

PTL 1: Japanese Patent Application Publication No. 2002-151769
PTL 2: Japanese Patent Application Publication No. H4-171879
PTL 3: Japanese Patent Application Publication No. H4-208582
PTL 4: Japanese Patent Application Publication No. H11-308882
PTL 5: Japanese Patent Application Publication No. H7-245549
PTL 6: Japanese Patent Application Publication No. H7-162067

### SUMMARY

A high-voltage pulse generator according to one aspect of the present disclosure, which is configured to apply a high voltage in a form of a pulse across a pair of discharge electrodes disposed in a laser chamber of a gas laser apparatus, may include a number “n” (n is a natural number of not less than 2) of primary electric circuits connected in parallel to one another on a primary side of a pulse transformer, and a secondary electric circuit of the pulse transformer, the secondary electric circuit being connected to the pair of discharge electrodes. The “n” primary electric circuits may include a number “n” of primary coils connected in parallel to one another, a number “n” of capacitors respectively connected in parallel to the “n” primary coils, and a number “n” of switches respectively connected in serial to the “n” capacitors. The secondary electric circuit may include a number “n” of secondary coils connected in series to one another, and a diode preventing a reverse current flowing from the pair of discharge electrodes toward the secondary coils. The “n” primary electric circuits may be connected to a number “n” of chargers configured to charge the “n” capacitors, respectively. The “n” capacitors may supply the “n” primary coils with a current corresponding to charge voltages charged by the “n” chargers while the “n” switches being driven. The diode may be constituted of a number “n” of diodes, each of the “n” diodes being connected to opposite ends of each of the “n” secondary coils, respectively.

A high-voltage pulse generator according to another aspect of the present disclosure, which is configured to apply a high voltage in a form of a pulse across a pair of discharge electrodes disposed in a laser chamber of a gas laser apparatus, may include a number “n” (n is a natural number of not less than 2) of primary electric circuits connected in parallel to one another on a primary side of a pulse transformer, a secondary electric circuit of the pulse transformer, the secondary electric circuit being connected to the pair of discharge electrodes, and a switch driver section. The “n” primary electric circuits may include a number “n” of primary coils connected in parallel to one another, a number “n” of capacitors respectively connected in parallel to the “n” primary coils, and a number “n” of switches respectively connected in serial to the “n” capacitors. The secondary electric circuit may include a number “n” of secondary coils connected in series to one another, and a diode preventing a reverse current flowing from the pair of discharge electrodes toward the secondary coils. The switch driver section may be configured to control driving each of the “n” switches on the basis of timing data determining drive timing for each of the “n” switches.

### BRIEF DESCRIPTION OF DRAWINGS

Some embodiments of the disclosure will be described as an example below with reference to the accompanying drawings.

FIG. 1 is a diagram illustrating a gas laser apparatus provided with a high-voltage pulse generator.

FIG. 2 is a diagram illustrating a discharge circuit of the gas laser apparatus shown in FIG. 1.

FIG. 3 is a diagram illustrating a configuration of the high-voltage pulse generator according to a first embodiment.

FIG. 4 is a flowchart schematically illustrating a process sequence performed by a laser controller to operate the high-voltage pulse generator of the first embodiment.

FIG. 5 is a flowchart illustrating a drive timing calculation process in step S3 of FIG. 4.

FIG. 6 is a timing chart illustrating the operation of the high-voltage pulse generator of the first embodiment.

FIG. 7 is a flowchart schematically illustrating a process sequence performed by a laser controller to operate a high-voltage pulse generator according to a second embodiment.

FIG. 8 is a flowchart illustrating a process for setting an initial value V0(t) in step S21 of FIG. 7.

FIG. 9 is a flowchart illustrating a drive timing calculation process in step S23 of FIG. 7.

FIG. 10 is a flowchart illustrating a process for setting a new apply voltage V(t) in step S29 of FIG. 7.

FIG. 11 is a timing chart illustrating the operation of the high-voltage pulse generator of the second embodiment.

FIG. 12 is a diagram illustrating a configuration of a high-voltage pulse generator according to a third embodiment.

FIG. 13 is a diagram illustrating a configuration of a high-voltage pulse generator according to a fourth embodiment.

FIG. 14 is a diagram illustrating a configuration of a high-voltage pulse generator according to a fifth embodiment.

FIG. 15 is a diagram illustrating a configuration of a high-voltage pulse generator according to a sixth embodiment.

FIG. 16 is a diagram illustrating a configuration of a high-voltage pulse generator according to a seventh embodiment.

FIG. 17 is a flowchart illustrating a drive timing calculation process performed by a laser controller involved in the seventh embodiment.

FIG. 18 is a diagram illustrating a configuration of a high-voltage pulse generator according to an eighth embodiment.

FIG. 19 is a diagram illustrating timing data input to a switch driver section shown in FIG. 18, as an example of a combination of two or more kinds of semiconductor switches that constitute a number “n” of switches and drive timing therefor.

FIG. 20 is a diagram illustrating a voltage output from a pulse power module shown in FIG. 18 by driving the “n” switches in the combination of semiconductor switches and at the drive timing shown in FIG. 19.

FIG. 21 is a diagram illustrating timing data input to a switch driver section involved in modification 1 of the eighth embodiment, as an example of a combination of two or more kinds of semiconductor switches that constitute a number “n” of switches and the drive timing therefor.

FIG. 22 is a diagram illustrating a voltage output from a pulse power module involved in modification 1 of the eighth embodiment by driving the “n” switches in the combination of semiconductor switches and at the drive timing shown in FIG. 21.

FIG. 23 is a diagram illustrating a configuration of a high-voltage pulse generator according to modification 2 of the eighth embodiment.

FIG. 24 is a block diagram illustrating respective hardware environments of controllers.

### EMBODIMENTS

### Contents

### 1. Overview

### 2. Terms

3. Gas Laser Apparatus With High-voltage Pulse Generator and Charge-discharge Circuit thereof

### 3.1 Configuration

### 3.2 Operation

### 4. Problem

### 5. High-voltage Pulse Generator of First Embodiment

### 5.1 Configuration

### 5.2 Operation

### 5.3 Effect

### 6. High-voltage Pulse Generator of Second Embodiment

### 6.1 Configuration

### 6.2 Operation

### 7. High-voltage Pulse Generator of Third Embodiment

### 8. High-voltage Pulse Generator of Fourth Embodiment

### 9. High-voltage Pulse Generator of Fifth Embodiment

### 10. High-voltage Pulse Generator of Sixth Embodiment

### 11. High-voltage Pulse Generator of Seventh Embodiment

### 12. High-voltage Pulse Generator of Eighth Embodiment

### 12.1 Configuration

### 12.2 Operation

### 12.3 Effect

### 12.4 Modification 1

### 12.5 Modification 2

### 13. Others

### 13.1 Hardware Environment of Each Controller

### 13.2 Other Modifications, etc.

In the following, some embodiments of the disclosure are described in detail with reference to the drawings. Embodiments described below each illustrate one example of the disclosure and are not intended to limit the contents of the disclosure. Also, all of the configurations and operations described in each embodiment are not necessarily essential for the configurations and operations of the disclosure. Note that like elements are denoted with the same reference numerals, and any redundant description thereof is omitted.

### 1. Overview

The present disclosure can at least disclose the following embodiments merely as examples.

A high-voltage pulse generator 5 according to the present disclosure, which applies a high voltage in the form of a pulse across a pair of discharge electrodes 11 disposed in a laser chamber 10 of a gas laser apparatus 1, may include a number “n” (n is a natural number of not less than 2) of primary electric circuits 511 to 51n connected in parallel to one another on a primary side of a pulse transformer TC, and a secondary electric circuit 52 of the pulse transformer TC, the secondary electric circuit being connected to the pair of discharge electrodes 11. The “n” primary electric circuits 511 to 51n may include a number “n” of primary coils La1 to Lan connected in parallel to one another, a number “n” of capacitors C1 to Cn respectively connected in parallel to the “n” primary coils La1 to Lan, and a number “n” of switches SW1 to SWn respectively connected in serial to the “n” capacitors C1 to Cn. The secondary electric circuit 52 may include a number “n” of secondary coils Lb1 to Lbn connected in series to one another, and a number “n” of diodes D1 to Dn preventing a reverse current flowing from the pair of discharge electrodes 11 toward the secondary electric circuit 52.

With this configuration, the high-voltage pulse generator 5 makes it possible to improve the efficiency of oscillation for pulse laser light.

### 2. Terms

“Optical path axis” is an axis extending in a traveling direction of a laser light through the beam sectional center of the laser light.

“Optical path” is a path along which the laser light travels. The optical path may include the optical path axis.

“Apply voltage” is a voltage which is going to be applied across a pair of discharge electrodes disposed in a laser chamber of a gas laser apparatus. The apply voltage may sometimes different from a voltage actually measured across the pair of discharge electrodes.

### 3. Gas Laser Apparatus with High-Voltage Pulse Generator and Charge-Discharge Circuit Thereof

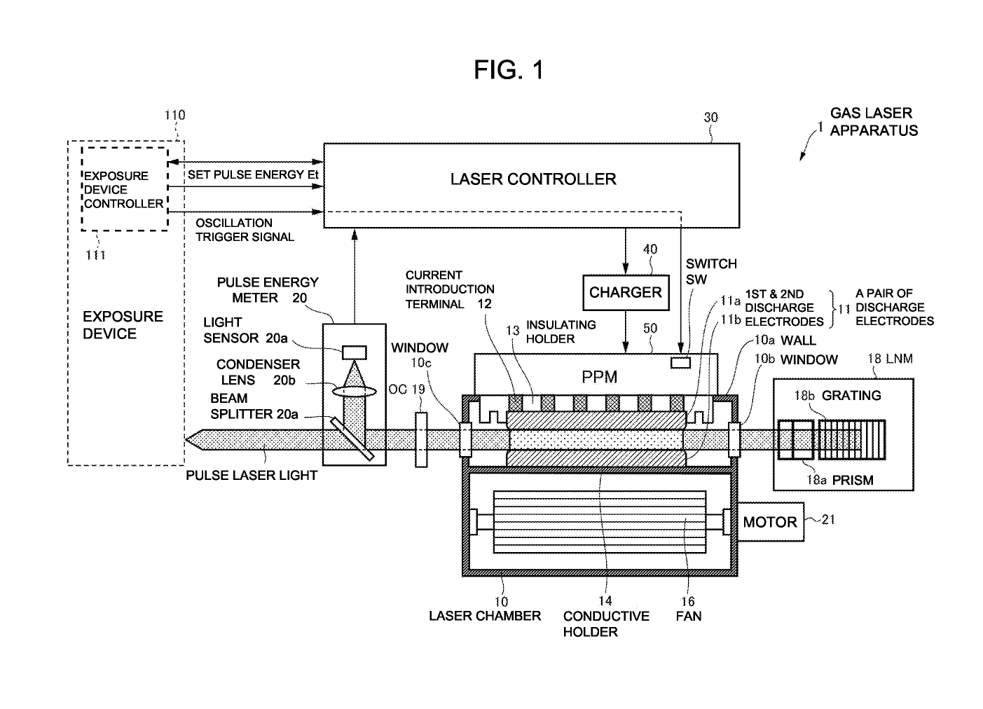

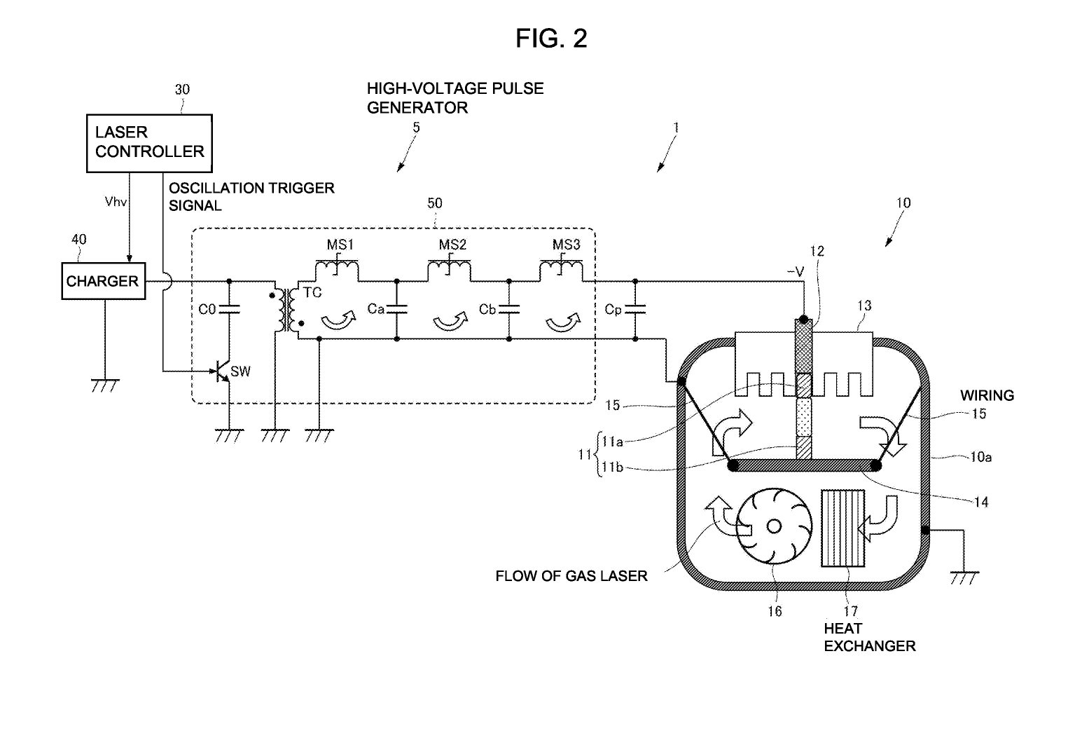

A gas laser apparatus 1 provided with a high-voltage pulse generator 5 and a charge-discharge circuit thereof will be described using FIG. 1 and FIG. 2.

The gas laser apparatus 1 may be a discharge excitation gas laser apparatus. The gas laser apparatus 1 may be an excimer laser apparatus. The laser gas, which is a laser medium, may be composed of argon or krypton or xenon as a rare gas, fluorine or chlorine as a halogen gas, neon or helium as a buffer gas, or a mixed gas thereof.

### 3.1 Configuration

FIG. 1 is a diagram illustrating the gas laser apparatus 1 provided with the high-voltage pulse generator 5. FIG. 2 is a diagram illustrating the charge-discharge circuit of the gas laser apparatus 1 shown in FIG. 1.

The gas laser apparatus 1 may include a laser chamber 10, a laser resonator, a pulse energy meter 20, a motor 21, a laser controller 30, a charger 40, a peaking capacitor Cp and a pulse power module (PPM) 50.

Note that a unit including the charger 40, the peaking capacitor Cp, the pulse power module 50 and the laser controller 30 may also be referred to as the high-voltage pulse generator 5.

The laser chamber 10 may have a laser gas encapsulated therein.

Walls 10a that form an internal room of the laser chamber 10 may be formed, for example, from a metal material, such as aluminum. The surface of the metal material may be treated with nickel plating, for example.

The laser chamber 10 may include a pair of discharge electrodes 11, a current introduction terminal 12, an insulating holder 13, a conductive holder 14, wirings 15, a fan 16 and a heat exchanger 17.

The pair of discharge electrodes 11 may include a first discharge electrode 11a and a second discharge electrode 11b.

The first and second discharge electrodes 11a and 11b may be electrodes for exciting the laser gas with main electric discharge. The main electric discharge may be glow discharge.

The first and second discharge electrodes 11a and 11b may be formed each from a metal material including copper for use with a halogen gas containing fluorine, or from a metal material including nickel for use with a halogen gas containing chlorine.

The first and second discharge electrodes 11a and 11b may be spaced a given distance from each other and arranged to face each other with the longitudinal direction thereof in parallel to each other.

The first and second discharge electrodes 11a and 11b may be a cathode electrode and an anode electrode, respectively.

One side of the first discharge electrode 11a facing the second discharge electrode 11b and one side of the second discharge electrode 11b facing the first discharge electrode 11a may also be called “discharge surface” each.

A space between the discharge surface of the first discharge electrode 11a and the discharge surface of the second discharge electrode 11b may also be called “discharge space”.

One end of the current introduction terminal 12 may be connected to a bottom surface of the first discharge electrode 11a, which is on the opposite side from the discharge surface.

The other end of the current introduction terminal 12 may be electrically connected through the peaking capacitor Cp to a negative output terminal of the pulse power module 50.

The insulating holder 13 may hold the first discharge electrode 11a and the current introduction terminal 12 so as to surround the side surfaces of the first discharge electrode 11a and the current introduction terminal 12.

The insulating holder 13 may be formed from an insulation material that hardly reacts with the laser gas. In the case where the laser gas contains fluorine or chlorine, the insulating holder 13 may be formed from high purity alumina ceramics, for example.

The insulating holder 13 may be secured to the wall 10a of the laser chamber 10.

The insulating holder 13 may be electrically connected to the wall 10a of the laser chamber 10.

The insulating holder 13 may electrically insulate the first discharge electrode 11a and the current introduction terminal 12 from the wall 10a of the laser chamber 10.

The conductive holder 14 may be connected to an opposite surface of the second discharge electrode 11b to the discharge surface, and may hold the second discharge electrode 11b.

The conductive holder 14 may be formed from a metal material including aluminum, copper and the like. The surface of the conductive holder may be treated with nickel plating.

The conductive holder 14 may be secured to the wall 10a of the laser chamber 10.

The conductive holder 14 may be electrically connected to the wall 10a of the laser chamber 10 through the wirings 15.

One end of the wiring 15 may be connected to the conductive holder 14.

The other end of the wiring 15 may be connected to a ground terminal of the pulse power module 50 through the wall 10a of the laser chamber 10 and the peaking capacitor Cp.

Multiple wirings 15 may be provided at predetermined intervals spaced from each other in the longitudinal direction of the first and second discharge electrodes 11a and 11b.

The fan 16 may circulate the laser gas inside the laser chamber 10.

The fan 16 may be a cross-flow fan.

The fan 16 may be arranged such that the longitudinal direction of the fan 16 is approximately parallel to the longitudinal direction of the first and second discharge electrodes 11a and 11b.

The fan 16 may be magnetically levitated by a not-shown magnetic bearing, and may be driven to rotate by the motor 21.

The heat exchanger 17 may exchange heat energy between a refrigerant supplied into the heat exchanger 17 and the laser gas.

The operation of the heat exchanger 17 may be controlled by the laser controller 30.

The motor 21 may rotate the fan 16.

The motor 21 may be a DC motor or an AC motor.

The operation of the motor 21 may be controlled by the laser controller 30.

The laser resonator may be constituted of a line narrowing module (LNM) 18 and an output coupler (OC) 19.

The line narrowing module 18 may include a prism 18a and a grating 18b.

The prism 18a may enlarge the beam width of light emitted from the laser chamber 10 through a window 10b. The prism 18a may transmit the enlarged beam therethrough toward the grating 18b.

The grating 18b may be a chromatic dispersion element having a large number of grooves formed at regular intervals on the surface thereof.

The grating 18b may be disposed in Littrow arrangement such that the incident angle and the diffraction angle become equal to each other.

From among the light transmitted through the prism 18a, the grating 18b may sort out light components around a particular wavelength according to the diffraction angle, and may feed the sorted rays back into the laser chamber 10. Thereby, the spectral width of the light returning from the grating 18b to the laser chamber 10 can be narrowed.

The output coupler 19 may transmit one part of the light projected through the window 10c from the laser chamber 10, as a pulse laser light and may reflect other parts of the light back into the laser chamber 10.

The surface of the output coupler 19 may be coated with a partial reflection film.

The pulse energy meter 20 may measure the pulse energy of the pulse laser light that has transmitted through the output coupler 19.

The pulse energy meter 20 may include a beam splitter 20a, a condenser lens 20b and a light sensor 20c.

The beam splitter 20a may be located on the optical path of the pulse laser light. The beam splitter 20a may transmit the pulse laser light with a high transmittance toward an exposure device 110 after the pulse laser light is transmitted through the output coupler 19. The beam splitter 20a may reflect part of the pulse laser light, transmitted through the output coupler 19, toward the condenser lens 20b.

The condenser lens 20b may focus the pulse laser light as reflected from the beam splitter 20a on a light reception surface of the light sensor 20c.

The light sensor 20c may detect the pulse laser light as focused on the light reception surface. The light sensor 20c may measure the pulse energy of the detected pulse laser light. The light sensor 20c may output a signal repetitive of the measured pulse energy to the laser controller 30.

The laser controller 30 may communicate various kinds of signals with an exposure device controller 111 provided in the exposure device 110.

For example, to the laser controller 30, the exposure device controller 111 may send a signal designating a target pulse energy Et of the pulse laser light to be output to the exposure device 110. The exposure device controller 111 may also send the laser controller 30 an oscillation trigger signal giving a cue for starting laser oscillation.

The laser controller 30 may conprehensively control the respective operations of the components of the gas laser apparatus 1 on the basis of the various kinds of signals from the exposure device controller 111. Particularly, the laser controller 30 may control other components included in the high-voltage pulse generator 5.

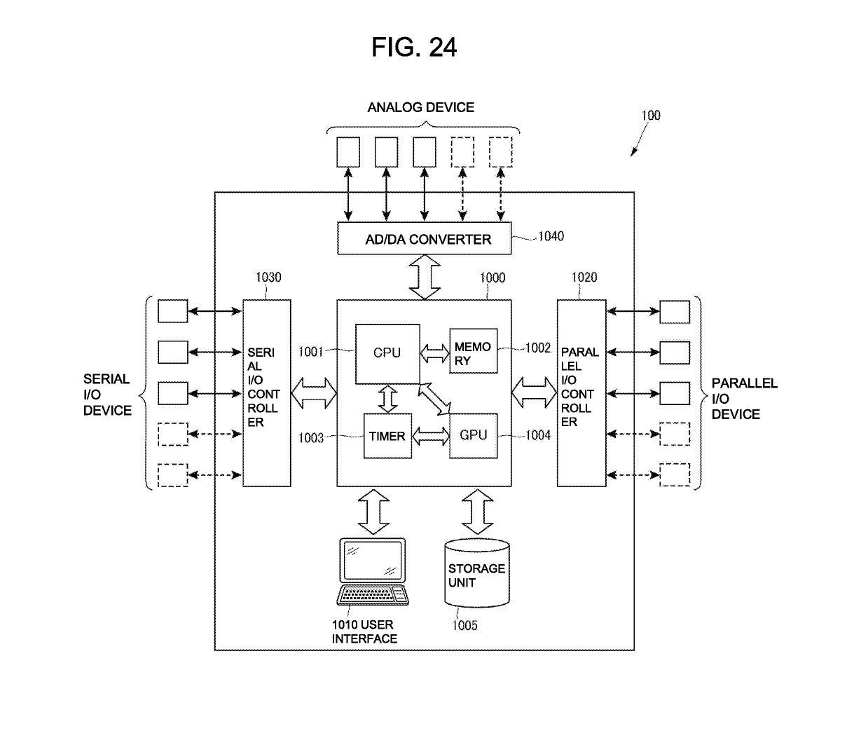

Note that hardware configurations of the laser controller 30 and the exposure device controller 111 will be described later, using FIG. 24.

The charger 40 may be a DC power supply device configured to charge a charge capacitor C0 included in the pulse power module 50 at a predetermined voltage.

The operation of the charger 40 may be controlled by the laser controller 30.

The peaking capacitor Cp may be disposed such that the electric charges charged by the pulse power module 50 is discharged across the space between the first discharge electrode 11a and the second discharge electrode 11b.

The peaking capacitor Cp may be connected in parallel to and between the pulse power module 50 and the laser chamber 10.

Alternatively, the peaking capacitor Cp may be placed inside the laser chamber 10. In this case, the area size of a region surrounded by a current path that constitutes a charge-discharge circuit of the gas laser apparatus 1 will be reduced so that the charge-discharge circuit can provide a smaller inductance. Thus, the energy loss at the discharge circuit can be preferably reduced.

The pulse power module 50 may apply the high-voltage pulse across the first and second discharge electrodes 11a and 11b through the peaking capacitor Cp.

The pulse power module 50 may be configured with a magnetic compressor circuit which makes use of magnetic saturation of magnetic switches to compress pulses.

As shown in FIG. 2, the pulse power module 50 may include a switch SW, a pulse transformer TC, magnetic switches MS1 to MS3, the charge capacitor C0 and capacitors Ca and Cb.

The switch SW may be a semiconductor switch.

The switch SW may be connected in series to a ground pole of a primary coil of the pulse transformer TC and the charge capacitor C0.

The operation of the switch SW may be controlled by the laser controller 30.

The magnetic switch MS1 may be provided between the secondary side of the pulse transformer TC and the capacitor Ca.

The magnetic switch MS2 may be provided between the capacitor Ca and the capacitor Cb.

The magnetic switch MS3 may be provided between the capacitor Cb and the peaking capacitor Cp.

When the time integral value of the voltage applied to the magnetic switches MS1 to MS3 reaches a threshold level, the magnetic switches MS1 to MS3 come to conduct the current easily. The threshold level may be different from one magnetic switch to another.

The state of the magnetic switch MS1, M2 or M3 in which the current flows easily therethrough may also be referred to as “the magnetic switch is closed”.

The primary side and the secondary side of the pulse transformer TC may be electrically insulated from each other. The winding direction of the primary coil of the pulse transformer TC may be reverse to the winding direction of the secondary coil. The winding number of the secondary coil of the pulse transformer TC may be greater than the winding number of the primary coil.

### 3.2 Operation

The laser controller 30 may receive a signal instructing preparation for laser oscillation, which is transmitted from the exposure device controller 111.

The laser controller 30 may control the motor 21 to rotate the fan 16.

The laser gas inside the laser chamber 10 can circulate. The laser gas can flow through the discharge space between the first discharge electrode 11a and the second discharge electrode 11b.

The laser controller 30 may receive the signal designating the target pulse energy Et, which is transmitted from the exposure device controller 111.

The laser controller 30 may set up the charger 40a with a voltage Vhv corresponding to the target pulse energy Et.

The charger 40 can charge the charge capacitor CO based on the set charge voltage Vhv.

The laser controller 30 may memorize the value of the voltage Vhv set up in the charger 40.

The laser controller 30 may receive the oscillation trigger signal transmitted from the exposure device controller 111.

The laser controller 30 may output the oscillation trigger signal to the switch SW of the pulse power module 50.

When the oscillation trigger signal is input to the switch SW, the switch SW can be turned ON and activated. When the switch SW is turned ON and activated, a pulsing current can flow from the charge capacitor C0 to the primary side of the pulse transformer TC.

When the current flows to the primary side of the pulse transformer TC, a pulsing current can flow in the opposite direction through the secondary coil of the pulse transformer TC due to electromagnetic induction. As the current flows through the secondary coil of the pulse transformer TC, the time integration value of the voltage applied to the magnetic switch MS1 can finally reach the threshold level.

When the time integration value of the voltage applied to the magnetic switch MS1 reaches the threshold level, the magnetic switch MS1 gets to a magnetically saturated state and the magnetic switch MS1 can be closed.

When the magnetic switch MS1 is closed, the current can flow from the secondary coil of the pulse transformer TC to the capacitor Ca, charging the capacitor Ca. At that time, the pulse width of the current charging the capacitor Ca can be reduced. The voltage level at the capacitor Ca can become negative.

As the current flows through the capacitor Ca, the time integration value of the voltage applied to the magnetic switch MS2 can finally reach the threshold level, and the magnetic switch MS2 can be closed.

When the magnetic switch MS2 is closed, the current can flow from the capacitor Ca to the capacitor Cb, charging the capacitor Cb. At that time, the pulse width of the current charging the capacitor Cb can be less than the pulse width of the current charging the capacitor Ca. The voltage level at the capacitor Cb can become negative.

As the current flows through the capacitor Cb, the time integration value of the voltage applied to the magnetic switch MS3 can finally reach the threshold level, and the magnetic switch MS3 can be closed.

When the magnetic switch MS3 is closed, the current can flow from the capacitor Cb to the peaking capacitor Cp, charging the peaking capacitor Cp. At that time, the pulse width of the current charging the peaking capacitor Cp can be less than the pulse width of the current charging the capacitor Cb. The voltage level at the peaking capacitor Cp can become negative.

Thus, as the current flows sequentially from the capacitor Ca to the capacitor Cb and from the capacitor Cb to the peaking capacitor Cp, the pulse width of the current can be compressed.

As being charged, the peaking capacitor Cp can apply a pulsing high-level voltage across the pair of discharge electrodes 11.

When the pulsing high-level voltage applied to the pair of discharge electrodes 11 becomes higher than a withstand voltage of the laser gas, the laser gas can dielectrically break down.

When the laser gas dielectrically breaks down, a main discharge can occur in the discharge space between the pair of discharge electrodes 11. At that time, the direction in which electrons move during the main discharge can be from the first discharge electrode 11a being the cathode electrode, to the second discharge electrode 11b being the anode electrode.

The occurrence of the main discharge enables exciting the laser gas to emit light in the discharge space between the pair of discharge electrodes 11.

The light emitted from the laser gas can be reflected by the line narrowing module 18 and the output coupler 19, which constitute the laser resonator, and thus reciprocate inside the laser resonator.

The light reciprocating within the laser resonator can be amplified at each passage through the discharge space, providing laser oscillation.

Thereafter, part of the amplified light can transmit through the output coupler 19. The light transmitted through the output coupler 19 can be output as a pulse laser light to the exposure apparatus 110.

Part of pulse laser light that has transmitted through the output coupler 19 may enter the pulse energy meter 20. The pulse energy meter 20 may measure the pulse energy of the incident pulse laser light and output the measured value to the laser controller 30.

The laser controller 30 may memorize the pulse energy value E measured by the pulse energy meter 20.

The laser controller 30 may calculate the difference ΔE between the measured pulse energy value E and the target pulse energy Et. The laser controller 30 may calculate the amount of change ΔVhv in voltage Vhv, which corresponds to the difference ΔE.

The laser controller 30 may calculate a newly-set voltage Vhv by adding the calculated amount of change ΔVhv to the previously memorized voltage Vhv.

The laser controller 30 may set up the charger 40 with the newly calculated voltage Vhv. Thus, the laser controller 30 may control the voltage Vhv while making the feedback of the voltage.

When the main discharge occurs, discharge products can be produced in the discharge space between the pair of discharge electrodes 11. The discharge products can move apart from the discharge space along with the flow of the laser gas that is flowing through the discharge space.

The laser gas flowing through the discharge space can flow to the heat exchanger 17, being cooled while passing through the heat exchanger 17. After passing through the heat exchanger 17, the laser gas can pass through the fan 16 and thus circulate inside the laser chamber 10.

As a result, the gas laser apparatus 1 can output the pulse laser light repeatedly at a frequency corresponding to the circulation cycle of the laser gas.

### 4. Problem

As described above, a high-voltage pulse generator 5 may be configured with a magnetic compression circuit.

The high-voltage pulse generator 5 using the magnetic compression circuit can carry out pulse compression and energy transfer using multistage LC resonation circuits each consisting of a magnetic switch and a capacitor. However, since the energy transfer efficiency is low and the size is large, this type of high-voltage pulse generator may have room for improvement.

The high-voltage pulse generator 5 using the magnetic compression circuit may further have room for improvement in that it takes a long time from the activation of the switch SW to the occurrence of main discharge across the pair of discharge electrodes 11, and the timing of occurrence of the main discharge itself can vary drastically.

In addition, the high-voltage pulse generator 5 using the magnetic compression circuit may also have room for improvement in that it is difficult to apply a high voltage with an optimum pulse waveform across the pair of discharge electrodes 11.

In particular, because the magnetic compression circuit is constituted of LC resonation circuits that consist of magnetic switches and capacitors, the voltage applied to the pair of discharge electrodes 11 can be fundamentally a sine wave. Therefore, it can be difficult for the high-voltage pulse generator 5 using the magnetic compression circuit to temporally control the amount of energy applied to the pair of discharge electrodes 11. Accordingly, in the high-voltage pulse generator 5 using the magnetic compression circuit, a large portion of the energy applied to the pair of discharge electrodes 11 can be wastefully converted to heat or can flow back toward the pulse power module 50 without being served for the laser oscillation.

Therefore, there is a demand for providing a new high-voltage pulse generator that can solve the problems involved in the high-voltage pulse generator 5 using a magnetic compression circuit.

### 5. High-Voltage Pulse Generator of First Embodiment

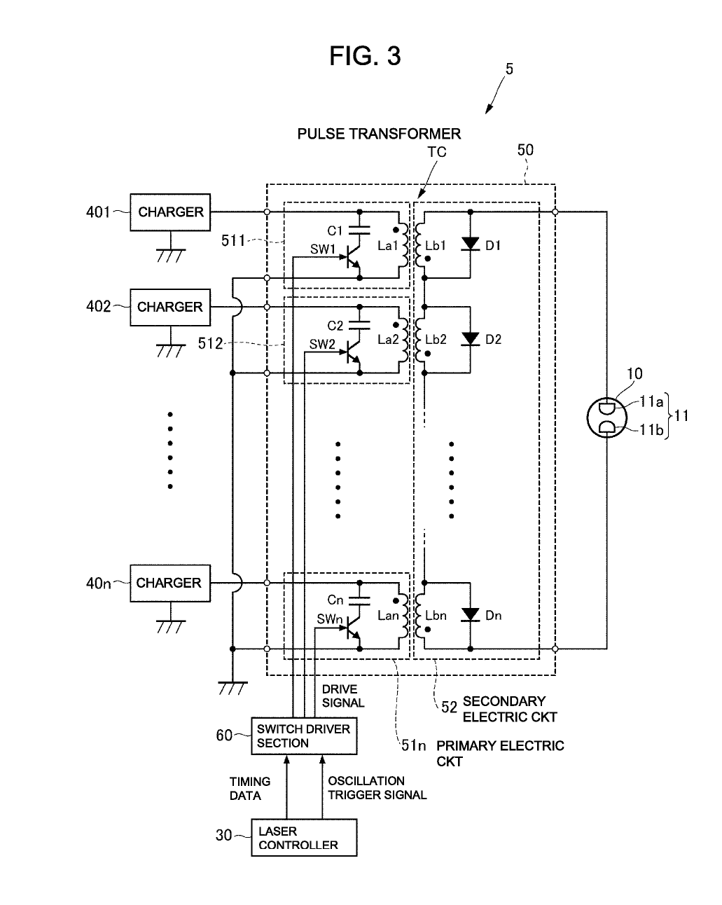

Using FIG. 3 to FIG. 6, a high-voltage pulse generator 5 of a first embodiment will be described.

Unlike the high-voltage pulse generator 5 shown in FIG. 2, the high-voltage pulse generator 5 of the first embodiment may be provided with a linear transformer driver (LTD), not a magnetic compression circuit.

Concerning the gas laser apparatus 1 provided with the high-voltage pulse generator 5 of the first embodiment, the description of the same features and operations as the gas laser apparatus 1 which is provided with the high-voltage pulse generator 5 shown in FIG. 2 will be omitted.

### 5.1 Configuration

FIG. 3 is a diagram illustrating a configuration of the high-voltage pulse generator 5 of the first embodiment.

The high-voltage pulse generator 5 of the first embodiment may be provided with a pulse power module 50, a number “n” of chargers 401 to 40n, a switch driver section 60 and a laser controller 30.

The number “n” may be a natural number of not less than two. The number “n” may be a natural number in a range of 15 to 30.

The pulse power module 50 shown in FIG. 3 may be a pulse compression circuit configured with a linear transformer driver (LTD).

The pulse power module 50 may include a number “n” of primary electric circuits 511 to 51n and a secondary electric circuit 52.

The “n” primary electric circuits 511 to 51n may be electric circuits disposed on the primary side of a pulse transformer TC which constitutes the pulse power module 50.

The “n” primary electric circuits 511 to 51n may be connected in parallel to one another.

The “n” primary electric circuits 511 to 51n may include a number “n” of primary coils La1 to Lan, a number “n” of capacitors C1 to Cn and a number “n” of switches SW1 to SWn.

Note that individual primary electric circuits included in the “n” primary electric circuits 511 to 51n, which are connected in parallel to one another, will be referred to as the primary electric circuit 511, the primary electric circuit 512, . . . the primary electric circuit 51n in the order of connection stages. Other components included in the high-voltage pulse generator 5 will be expressed in the same way. For instance, the primary electric circuit 511 connected in the first stage that is on the top side in FIG. 3 may include one primary coil La1, one capacitor C1 and one switch SW1.

The “n” primary coils La1 to Lan may be primary coils of the pulse transformer TC.

The “n” primary coils La1 to Lan may be connected in parallel to one another.

One ends of the “n” primary coils La1 to Lan may be connected to the “n” chargers 401 to 40n, respectively.

The other ends of the “n” primary coils La1 to Lan may be individually grounded.

The “n” capacitors C1 to Cn may be connected in parallel to the “n” primary coils La1 to Lan, respectively.

One terminals of the “n” capacitors C1 to Cn may be individually connected to wires which interconnect the “n” primary coils La1 to Lan and the “n” chargers 401 to 40n, respectively.

The other terminals of the “n” capacitors C1 to Cn may be connected to the “n” switches SW1 to SWn, respectively.

The “n” switches SW1 to SWn may be connected in series to the “n” capacitors C1 to Cn, respectively.

One ends of the “n” switches SW1 to SWn may be connected to the “n” capacitors C1 to Cn, respectively.

The other ends of the “n” switches SW1 to SWn may be connected to wires which connect the “n” primary coils La1 to Lan to the ground, respectively.

Furthermore, the “n” switches SW1 to SWn may be individually connected to the switch driver section 60. The “n” switches SW1 to SWn may be activated under the control of the switch driver section 60.

Activating the “n” switches SW1 to SWn enables the “n” capacitors C1 to Cn to supply a current to the “n” primary coils La1 to Lan according to a charge voltage charged by the “n” chargers 401 to 40n, respectively.

Incidentally, as the current flows through one of the “n” primary coils La1 to Lan, an electromagnetically induced current can flow through a corresponding one of the “n” secondary coils Lb1 to Lbn in the opposite direction to the current through the primary coil.

Activating the “n” switches SW1 to SWn to supply currents to the “n” primary coils La1 to Lan and thus conducting currents through the secondary coils Lb1 to Lbn can be interpreted as driving the “n” primary electric circuits 511 to 51n.

The secondary electric circuit 52 may be a secondary electric circuit of the pulse transformer TC which constitutes the pulse power module 50.

The secondary electric circuit 52 may include a number “n” of secondary coils Lb1 to Lbn and a number “n” of diodes D1 to Dn.

The “n” secondary coils Lb1 to Lbn may be secondary coils of the pulse transformer TC.

The “n” secondary coils Lb1 to Lbn may be connected in series to one another.

The “n” secondary coils Lb1 to Lbn may be connected in series to the pair of discharge electrodes 11.

Among the “n” secondary coils Lb1 to Lbn, the secondary coil Lb1 in the first stage and the secondary coil Lbn in the last stage may be connected to the first and second discharge electrodes 11a and 11b, respectively.

The “n” diodes D1 to Dn may prevent against a reverse current that flows from the pair of discharge electrodes 11 toward the secondary coils Lb1 to Lbn.

The “n” diodes D1 to Dn may be bypass diodes which protect the “n” secondary coils Lb1 to Lbn from the reverse current, respectively.

The “n” diodes D1 to Dn may be connected between the opposite ends of each of the “n” secondary coils Lb1 to Lbn in such a direction that the reverse current can flow through the diodes.

The “n” chargers 401 to 40n may be a DC power supply device each.

The “n” chargers 401 to 40n may be connected to the “n” primary electric circuits 511 to 51n, respectively.

The “n” chargers 401 to 40n may charge the “n” capacitors C1 to Cn at predetermined charge voltages, respectively.

The “n” chargers 401 to 40n may charge the “n” capacitors C1 to Cn at an approximately equal charge voltage ΔV. The charge voltage ΔV may be around 1 kV, for example.

The operation of the “n” chargers 401 to 40n may be controlled by the laser controller 30.

The switch driver section 60 may be connected to the “n” switches SW1 to SWn, individually.

The switch driver section 60 may be connected to the laser controller 30.

To the switch driver section 60, the laser controller 30 may output timing data and an oscillation trigger signal.

The switch driver section 60 may control activation of the “n” switches SW1 to SWn on the basis of the timing data and the oscillation trigger signal.

The switch driver section 60 may control activation of the “n” switches SW1 to SWn by outputting a drive signal to each of the “n” switches SW1 to SWn.

The operation of the switch driver section 60 may be controlled by the laser controller 30.

The timing data may designate the timing to drive the “n” switches SW1 to SWn each individually.

The timing data may include information on which switches SW among the “n” switches SW1 to SWn should be driven at predetermined drive timing.

The number of switches SW to be driven among the “n” switches SW1 to SWn and the designation of each switch SW to be driven may be determined on the basis of a target pulse energy Et of pulse laser light to be output from the gas laser apparatus 1.

The predetermined drive timing may be at a time point which is behind the oscillation trigger signal by a predetermined delay time T1.

The predetermined drive timing for the switches SW to be driven may be substantially simultaneous with each other.

Note that the hardware configuration of the switch driver section 60 will be described later with reference to FIG. 24.

Other features of the high-voltage pulse generator 5 involved in the first embodiment may be the same as those of the high-voltage pulse generator 5 shown in FIG. 2.

### 5.2 Operation

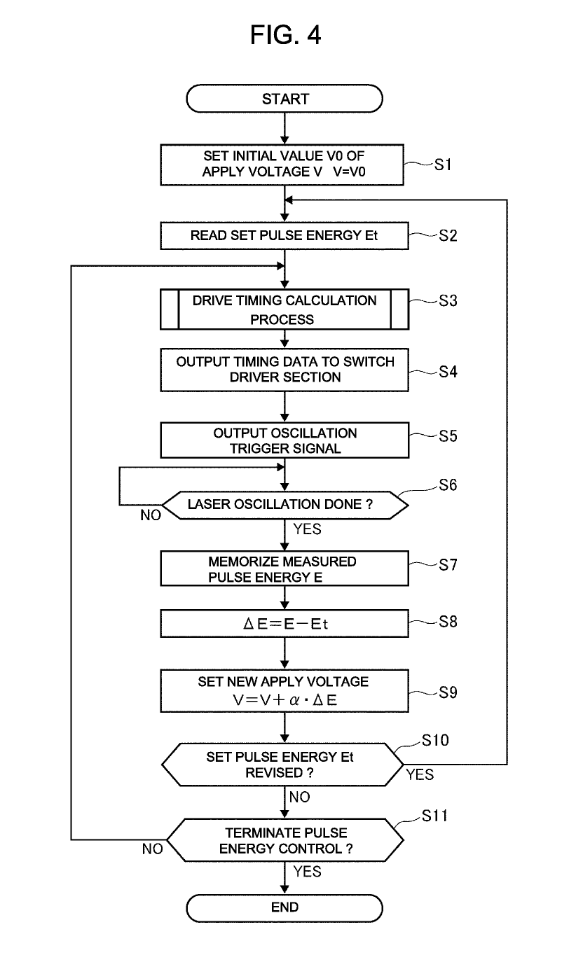

Referring to FIG. 4 to FIG. 6, the operation of the high-voltage pulse generator 5 of the first embodiment will be described.

In particular, a process sequence performed by the laser controller 30 for operating the high-voltage pulse generator 5 of the first embodiment to control the pulse energy of pulse laser light will be described.

FIG. 4 is a flowchart schematically illustrating the process sequence performed by the laser controller 30 to operate the high-voltage pulse generator 5 of the first embodiment.

In step S1, the laser controller 30 may determine an initial value V0 as an apply voltage V to be applied across the pair of discharge electrodes 11.

The initial value V0 may be at least a voltage that enables causing a main discharge across the pair of discharge electrodes 11. The initial value V0 may be about 10 to 30 kV, for example.

In step S1, the laser controller 30 may determine the initial value V0 of the apply voltage V according to the following equation:

V=V0

In step S2, the laser controller 30 may read the target pulse energy Et designated by the exposure device controller 111.

In step S3, the laser controller 30 may execute a drive timing calculation process.

The drive timing calculation process may be a process for calculating the drive timing for each of the “n” switches SW1 to SWn.

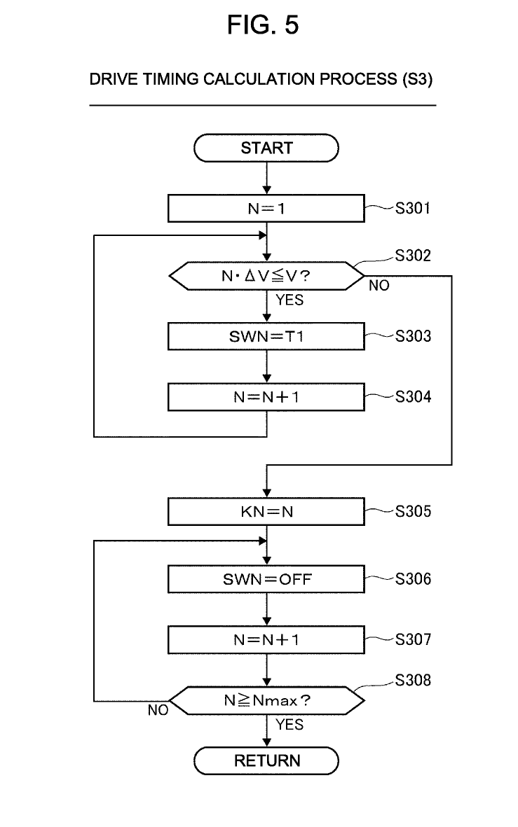

The detail of the drive timing calculation process will be described later using FIG. 5.

In step S4, the laser controller 30 may output timing data produced in step S3 to the switch driver section 60.

In step S5, the laser controller 30 may output the oscillation trigger signal from the exposure device controller 111 to the switch driver section 60.

The switch driver section 60 may control activation of the “n” switches SW1 to SWn on the basis of the timing data and oscillation trigger signal.

Specifically, among the “n” switches SW1 to SWn, those switches SW which are designated by the timing data may be driven by the switch driver section 60 at a time point lagged by the delay time T1 from the oscillation trigger signal.

The number and assignment of switches SW to be driven among the “n” switches SW1 to SWn will be described later using FIG. 5.

In step S6, the laser controller 30 may determine whether a laser oscillation has been carried out or not.

If the laser oscillation has not been carried out, the laser controller 30 may stand by until the laser oscillation. Meanwhile, if the laser oscillation has been carried out, the laser controller 30 may proceed to step S7.

In step S7, the laser controller 30 may memorize a pulse energy value E measured by the pulse energy meter 20.

In step S8, the laser controller 30 may calculate a difference ΔE between the measured pulse energy value E and the target pulse energy Et.

The laser controller 30 may calculate the difference ΔE according to the following equation:

ΔE=E−Et

In step S9, the laser controller 30 may determine a new apply voltage V so as to reduce the difference ΔE to be close to 0.

The laser controller 30 may determine the new apply voltage V according to the following equation:

V=V+α·ΔE

wherein, α on the right side may be a constant of proportion previously determined by experience and the like.

In step S10, the laser controller 30 may determine whether or not the target pulse energy Et is revised.

The exposure device controller 111 can revise the target pulse energy Et. In that case, the exposure device controller 111 may output a signal designating the revised target pulse energy Et to the laser controller 30.

The laser controller 30 may proceed to step S2 if the target pulse energy Et is revised. If the target pulse energy Et is not revised, the laser controller 30 may proceed to step S11.

In step S11, the laser controller 30 may determine whether to terminate the process for controlling the pulse energy of pulse laser light, or not.

The laser controller 30 may proceed to step S3 if the process for controlling the pulse energy of pulse laser light is not to be terminated. Meanwhile, if the process for controlling the pulse energy of pulse laser light is to be terminated, the laser controller 30 may terminate the process.

FIG. 5 is a flowchart illustrating the drive timing calculation process in step S3 of FIG. 4.

In step S301, the laser controller 30 may set an identification number N to be 1.

The identification number N may be a serial number given for identification to each of the primary electric circuits 511 to 51n, the secondary electric circuit 52 and the chargers 401 to 40n included in the high-voltage pulse generator 5 as well as the elements included in these components.

For example, among the “n” primary electric circuits 511 to 51n, the identification number N of the primary electric circuit 511 in the first stage from the top side of FIG. 3 may be 1. Likewise, the primary coil La1, the capacitor C1 and the switch SW1 included in the primary electric circuit 511 may be assigned with the identification number N=1. Also, the identification number N of the charger 401 connected to the primary electric circuit 511 among the “n” chargers 401 to 40n may be 1. Likewise, among the “n” secondary coils Lb1 to Lbn included in the secondary electric circuit, the secondary coil Lb1 as the counterpart of the primary coil La1 and the diode D1 connected across the opposite ends of the secondary coil Lb1 may be assigned with the identification number N=1.

Alternatively, the identification number N may be a serial number given for identification to each of limited ones of the primary electric circuits 511 to 51n, the secondary electric circuit 52 and the chargers 401 to 40n included in the high-voltage pulse generator 5 as well as the elements included in these limited components which are nominated as candidates to serve for generating the apply voltage V.

In step 301, the laser controller 30 may determine the identification number N according the following equation:

N=1

In step S302, the laser controller 30 may determine whether or not a value N·ΔV, which represents a total charge voltage charged in the capacitors C1 to CN by the chargers 401 to 40N with identification numbers up to N, is equal to or less than the apply voltage V to be applied across the pair of discharge electrodes 11.

As described above, the “n” chargers 401 to 40n may respectively charge the “n” capacitors C1 to Cn at an equal charge voltage ΔV to each other.

The laser controller 30 may proceed to step S305 if the total charge voltage N·ΔV is higher than the apply voltage V. Meanwhile, if the total charge voltage N·ΔV is not higher than the apply voltage V, the laser controller 30 may proceed to step S303.

In step S303, the laser controller 30 may determine the drive timing for one switch SWN that is assigned with the identification number N.

Specifically, the laser controller 30 may determine the switch SWN with the identification number N to be driven at a time point that is by the delay time T1 behind the oscillation trigger signal.

The laser controller 30 may determine the drive timing for the switch SWN with the identification number N according to the following equation:

SWN=T1

In step S304, the laser controller 30 may revise the identification number N.

The laser controller 30 may revise the identification number N by increment according to the following equation.

N=N+1

Thereafter, the laser controller 30 may proceed to step S302.

In step S305, the laser controller 30 may determine a threshold number KN.

The threshold number KN may be a particular identification number N that represents a border between activating primary electric circuits which are to be activated and non-activating primary electric circuits which are not to be activated among the “n” primary electric circuits 511 to 51n. Those primary electric circuits 511 to 51KN-1 which are in front stages before the border represented by the threshold number KN may be the activating primary electric circuits. Those primary electric circuits 51KN to 51Nmax which are in rear stages behind the border represented by the threshold number KN may be the non-activating primary electric circuits.

The threshold number KN can be determined according to the apply voltage V to be applied across the pair of discharge electrodes 11.

The maximum identification number Nmax may be a total number of the primary electric circuits 511 to 51n included in the high-voltage pulse generator 5. In the example shown in FIG. 3, Nmax may be equal to “n”.

In an alternative in where the identification numbers N are given to those elements which are nominated for use in generating the apply voltage V, the maximum identification number Nmax may be a natural number of not less than 2 but less than “n”.

The laser controller 30 may determine the threshold number KN according to the following equation:

KN=N

In step S306, the laser controller 30 may determine the drive timing for one switch SWN with one identification number N.

The switch SWN for which the drive timing is determined in step S306 may be one of switches SWK to SWNmax which are assigned with identification numbers N from the threshold number KN in ascending order. The laser controller 30 may determine so as these switches SWN not to be activated.

In step S306, the laser controller 30 may determine the drive timing for the switch SWN with the identification number N according to the following equation:

SWN=OFF

In step S307, the laser controller 30 may revise the identification number N.

The laser controller 30 may revise the identification number N by increment according to the following equation:

N=N+1

In step S308, the laser controller 30 may determine whether or not the revised identification number N reaches or exceeds the maximum identification number Nmax.

The laser controller 30 may proceed to step S306 if the revised identification number N is less than the maximum identification number Nmax. If the revised identification number N reaches or exceeds the maximum identification number Nmax, the laser controller 30 may terminate the present drive timing calculation process and thereafter produce the timing data, and then proceed to step S4 of the sequence in FIG. 4.

Through the processes as described above, if a necessary apply voltage V can be generated by charging the capacitors C1 to CKN-1 and supplying a current corresponding to the charged voltage to the primary coils La1 to LaKN-1, the laser controller 30 can drive only those switches SW1 to SWKN-1 which have identification numbers lower than the threshold number KN.

In addition, the laser controller 30 may determine the drive timing such that each of the switches SW1 to SWKN-1 are driven at a time point lagged by the delay time T1 from the oscillation trigger signal.

Meanwhile, the laser controller 30 may determine not to drive the switches SWKN to SWNmax having identification numbers equal to or higher than the threshold number KN.

In other words, the laser controller 30 may determine the timing data such that the switches SW1 to SWKN-1 are driven with the delay time T1 from the oscillation trigger signal and the switches SWKN to SWNmax are not activated.

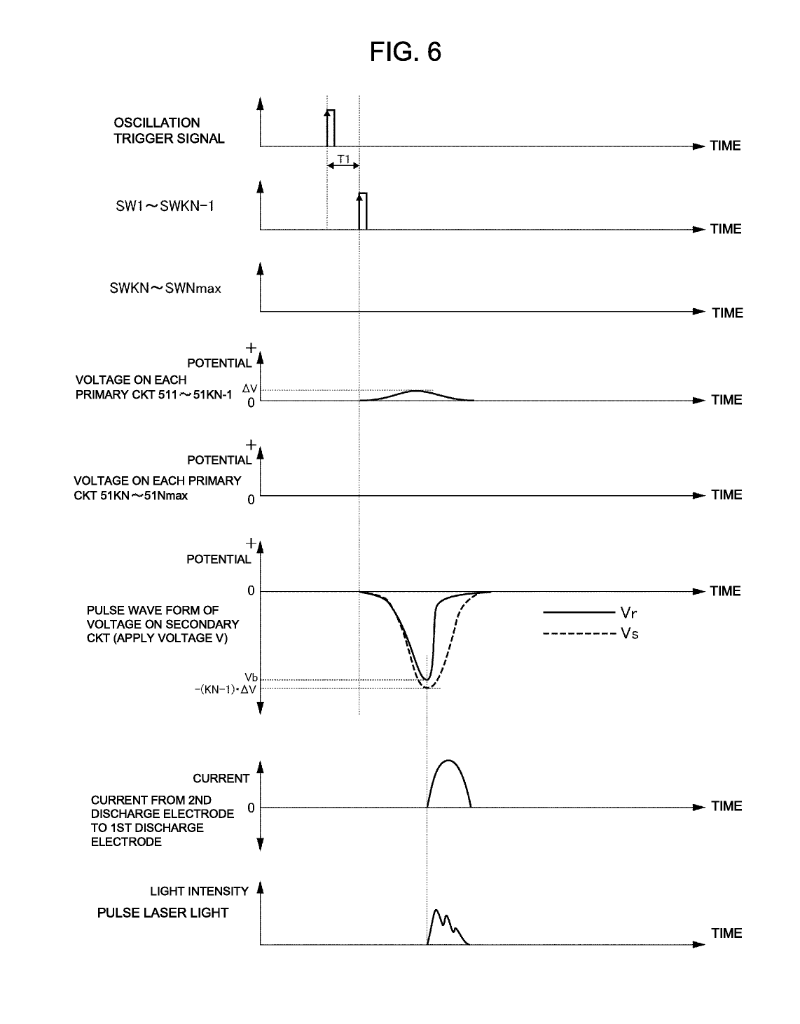

FIG. 6 is a timing chart illustrating the operation of the high-voltage pulse generator 5 of the first embodiment.

To the switch driver section 60, the laser controller 30 may output the timing data and the oscillation trigger signal.

Upon input of the oscillation trigger signal, the switch driver section 60 may drive the switches SW1 to SWKN-1 at a time point lagged by delay time T1 from the time of input of the oscillation trigger signal. The switch driver section 60 may not have to drive the switches SWKN to SWNmax.

The primary electric circuits 511 to 51KN-1 can be driven in synchronism with the drive timing for the switches SW1 to SWKN-1, respectively, generating a voltage with a pulse waveform that has a peak level corresponding to the charge voltage ΔV.

Meanwhile, the primary electric circuits 51KN to 51Nmax can stay inactivated because the switches SWKN to SWNmax are not activated.

The secondary electric circuit 52 can generate an apply voltage V corresponding to a voltage Vs that is a sum of voltages respectively generated from the primary electric circuits 511 to 51KN-1.

The absolute value of the peak of the voltage Vs in the pulse waveform can be (KN−1)·ΔV. The peak absolute value (KN−1)·ΔV can correspond to the apply voltage V necessary for outputting pulse laser light with the target pulse energy Et.

An apply voltage Vr actually measured across the pair of discharge electrodes 11 can have such a pulse waveform that substantially corresponds to the pulse waveform of the voltage Vs in a region before the laser gas is broken down but, in a region after the dielectric breakdown, the voltage level of the voltage Vr is more rapidly closing to 0.

When a breakdown voltage Vb caused by the dielectric breakdown of the laser gas is applied across the pair of discharge electrodes 11, a main discharge can occur across the pair of discharge electrodes 11, causing a current to flow from the second discharge electrode 11b to the first discharge electrode 11a.

Then, the laser gas existing in the discharge space between the pair of discharge electrodes 11 can be excited to emit light, outputting pulse laser light from the gas laser apparatus 1.

Other operations of the high-voltage pulse generator 5 of the first embodiment may be the same as those of the high-voltage pulse generator 5 shown in FIG. 2.

### 5.3 Effect

In the high-voltage pulse generator 5 of the first embodiment, it is possible to change the activating primary electric circuits by changing the activating switches SW among the “n” switches SW1 to SWn. In particular, the high-voltage pulse generator 5 of the first embodiment can determine the necessary apply voltage V on the basis of the target pulse energy Et of the pulse laser light and change the activating primary electric circuits in accordance with the determined apply voltage V.

Thus, the high-voltage pulse generator 5 of the first embodiment can control the pulse waveform of the apply voltage V applied across the pair of discharge electrodes 11 to be a pulse waveform that is appropriate for achieving the target pulse energy Et.

As a result, the high-voltage pulse generator 5 of the first embodiment can control the pulse energy of the output pulse laser light to the target pulse energy Et with high accuracy.

In addition, when the target pulse energy Et is revised, the high-voltage pulse generator 5 of the first embodiment can immediately revise the activating switches SW and the drive timing thereof by changing the timing data.

Therefore, the high-voltage pulse generator 5 of the first embodiment can immediately change the activating primary electric circuits and the drive timing thereof, enabling rapid control of the energy fed to the pair of discharge electrodes 11.

In results, the high-voltage pulse generator 5 of the first embodiment can make the energy fed to the pair of discharge electrodes 11 efficiently contribute to the laser oscillation and thus achieve an improvement in oscillation efficiency of the pulse laser light.

Furthermore, because the switch SW of the pulse power module 50 can be constituted of a number “n” of switches SW1 to SWn in the high-voltage pulse generator 5 of the first embodiment, it is possible to lower the requirement for the withstand voltage to the individual switches SW1 to SWn.

Accordingly, the high-voltage pulse generator 5 of the first embodiment can permit serving relatively inexpensive semiconductor switches for constituting the switch SW of the pulse power module 50 and thus enables an improvement in flexibility of the circuit design.

The high-voltage pulse generator 5 of the first embodiment can prevent the reverse current, which flows from the pair of discharge electrodes 11 to the secondary coils Lb1 to Lbn, by the “n” diodes D1 to Dn.

Thereby, the high-voltage pulse generator 5 of the first embodiment can prevent voltage generation on the side of the “n” primary coils La1 to Lan due to electromagnetic induction caused by the reverse current, and thus prevent the “n” switches SW1 to SWn and the “n” chargers 401 to 40n from being damaged.

Furthermore, the high-voltage pulse generator 5 of the first embodiment can be configured with LTDs that carry out the pulse compression without using the phenomenon of magnetic saturation.

Accordingly, the high-voltage pulse generator 5 of the first embodiment can improve the energy transfer efficiency as well as reduce the size in comparison with the high-voltage pulse generator 5 using the magnetic compression circuit.

In addition, the high-voltage pulse generator 5 of the first embodiment can save time from the time poit at which the switch SW is driven to the time point at which the main discharge occurs, as well as stabilize the timing of occurrence of the main discharge.

### 6. High-Voltage Pulse Generator of Second Embodiment

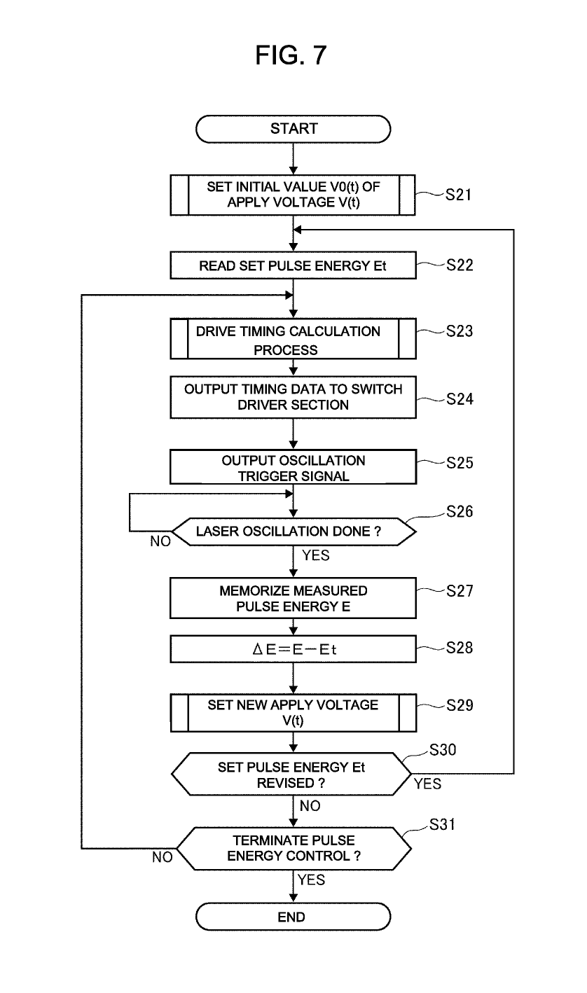

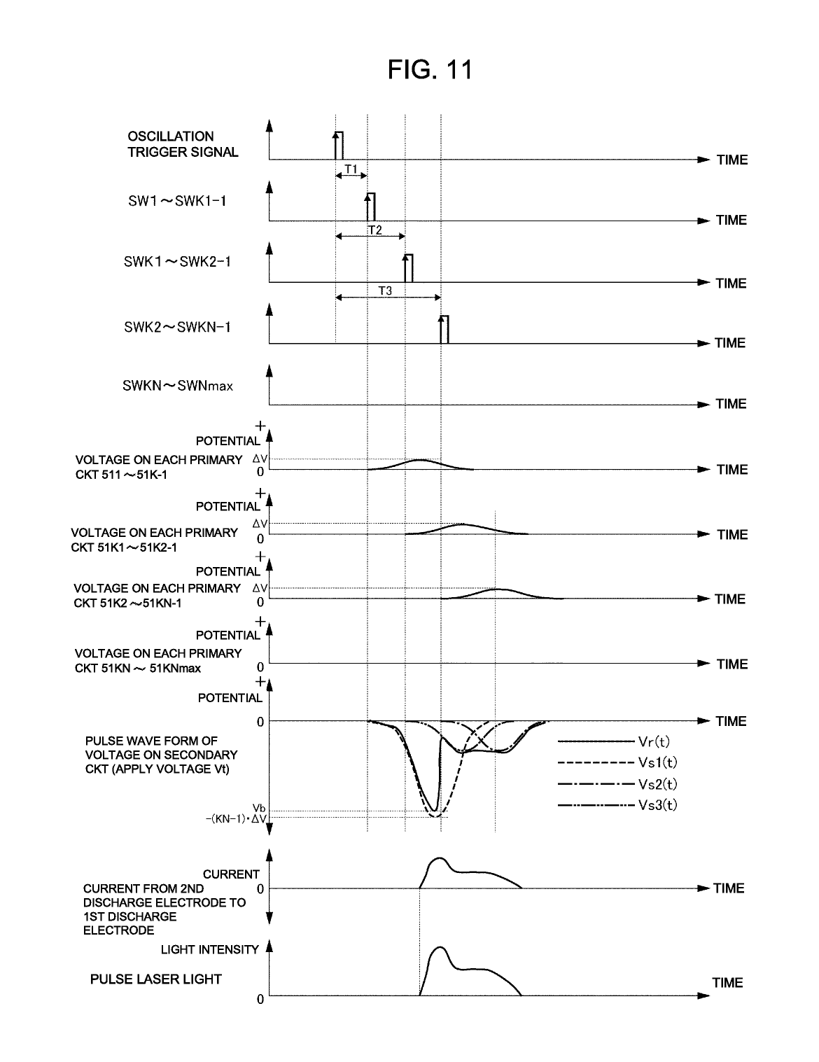

Referring to FIG. 7 and FIG. 11, a high-voltage pulse generator 5 of a second embodiment will be described.

In the high-voltage pulse generator 5 of the first embodiment, the pulse waveform of the apply voltage V applied across the pair of discharge electrodes 11 can have a single peak, as shown in FIG. 6. That is, in the high-voltage pulse generator 5 of the first embodiment, the peak level of the apply voltage V can change as with the target pulse energy Et, but the pulse waveform of the apply voltage V itself does not change to an appropriate form.

However, it may be preferable for the gas laser apparatus 1 to apply a voltage V to the pair of discharge electrodes 11 in such a pulse waveform that varies with time. In that case, since the high-voltage pulse generator 5 of the first embodiment cannot change the pulse waveform of the apply voltage V, part of the energy fed to the pair of discharge electrodes 11 may be lost in vain.

The high-voltage pulse generator 5 of the second embodiment may be configured to drive some of the “n” switches SW1 to SWn at a particular drive timing and other of the “n” switches SW1 to SWn at a different drive timing in accordance with an apply voltage V with a pulse waveform which varies with time.

The structure of the high-voltage pulse generator 5 of the second embodiment may be the same as that of the high-voltage pulse generator 5 of the first embodiment. The operation of the high-voltage pulse generator 5 of the second embodiment may mainly differ from the high-voltage pulse generator 5 of the first embodiment in processing performed by the laser controller 30.

Concerning the gas laser apparatus 1 provided with the high-voltage pulse generator 5 of the second embodiment, the description of the same features and operations as the gas laser apparatus 1 provided with the high-voltage pulse generator 5 of the first embodiment will be omitted.

### 6.1 Operation

FIG. 7 is a flowchart schematically illustrating a process sequence performed by the laser controller 30 to operate the high-voltage pulse generator 5 according to the second embodiment.

In step S21, the laser controller 30 may determine an initial value V0(t) as the initial value of an apply voltage V(t) to be applied across the pair of discharge electrodes 11.

The apply voltage V(t) represents a value of the apply voltage V at a particular time point t, indicating that the apply voltage V can vary with time.

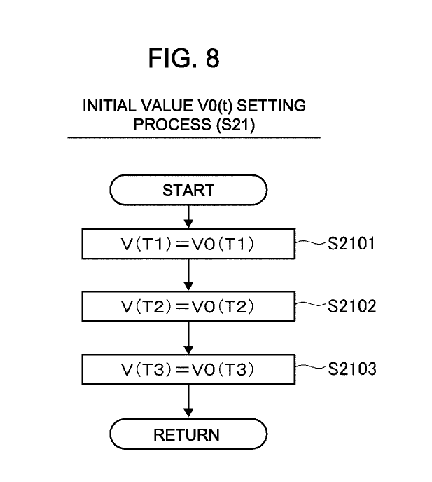

The detail of the process for determining the initial value V0(t) will be described later with reference to FIG. 8.

In step S22, the laser controller 30 may read the target pulse energy Et designated by the exposure device controller 111.

In step S23, the laser controller 30 may execute a drive timing calculation process.

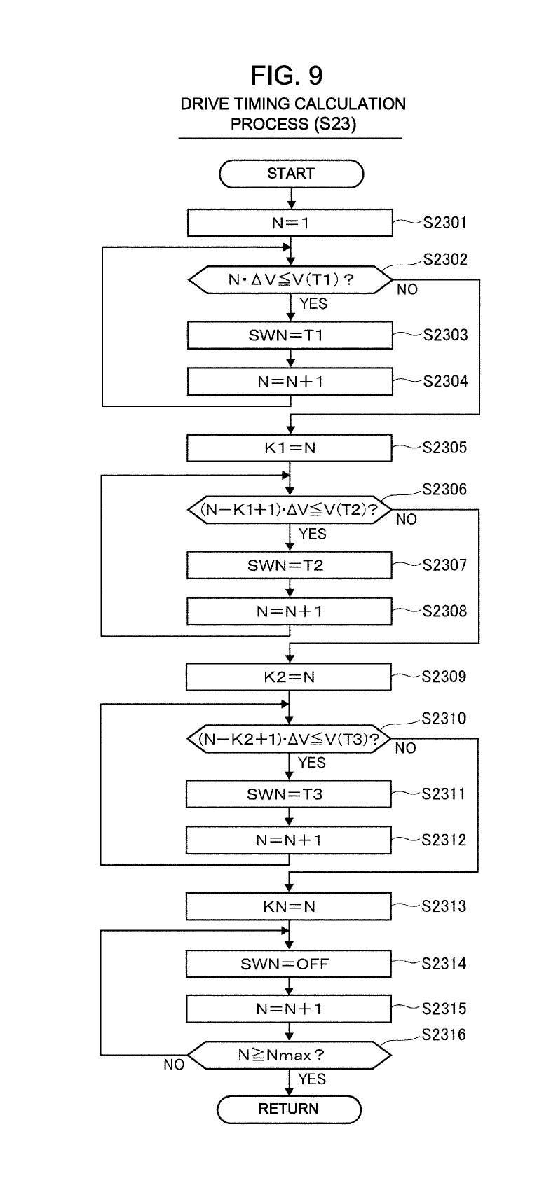

The detail of the drive timing calculation process will be described later with reference to FIG. 9.

In steps S24 and S25, the laser controller 30 may make the same processes as in steps S4 and S5 shown in FIG. 4.

In step S26, the laser controller 30 may determine whether or not a laser oscillation has been carried out.

If the laser oscillation has not been carried out, the laser controller 30 may stand by until the laser oscillation. Meanwhile, if the laser oscillation has been carried out, the laser controller 30 may proceed to step S27.

In steps S27 and S28, the laser controller 30 may make the same processes as in steps S7 and S8 shown in FIG. 4.

In step S29, the laser controller 30 may determine a new apply voltage V(t) so as to reduce the difference ΔE to be close to 0.

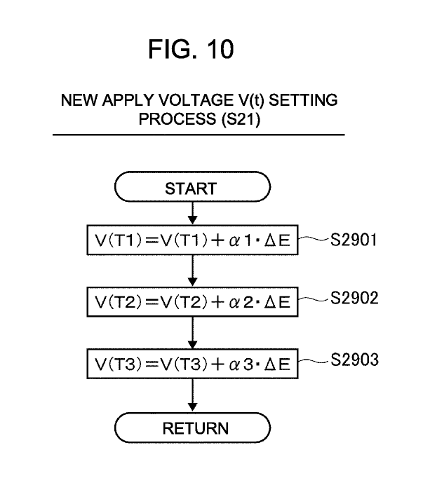

The detail of the process for determining the new apply voltage V(t) will be described later with reference to FIG. 10.

In step S30, the laser controller 30 may determine whether or not the target pulse energy Et is revised.

If the target pulse energy Et is revised, the laser controller 30 may proceed to step S22. Meanwhile, if the target pulse energy Et is not revised, the laser controller 30 may proceed to step S31.

In step S31, the laser controller 30 may determine whether or not the process for controlling the pulse energy of pulse laser light is to be terminated.

If the process for controlling the pulse energy of pulse laser light is not to be terminated, the laser controller 30 may proceed to step S23. Meanwhile, if the process for controlling the pulse energy of pulse laser light is to be terminated, the laser controller 30 may terminate the present process sequence.

FIG. 8 is a flowchart illustrating a process for setting an initial value V0(t) in step S21 of FIG. 7.

In step S2101 [symbol] , the laser controller 30 may determine the initial value V0(T1) of the apply voltage V(T1) at a time point lagged by a delay time T1 from an oscillation trigger signal.

The laser controller 30 may determine the initial value V0(T1) of the apply voltage V(T1) according to the following equation:

V(T1)=V0(T1)

In step S2102, the laser controller 30 may determine the initial value V0(T2) of the apply voltage V(T2) at a time point lagged by a delay time T2 from the oscillation trigger signal.

The laser controller 30 may determine the initial value V0(T2) of the apply voltage V(T2) according to the following equation:

V(T2)=V0(T2)

In step S2103, the laser controller 30 may determine the initial value V0(T3) of the apply voltage V(T3) at a time point lagged by a delay time T3 from the oscillation trigger signal.

The laser controller 30 may determine the initial value V0(T3) of the apply voltage V(T3) according to the following equation:

V(T3)=V0(T3)

Incidentally, the delay times T1 to T3 may be any length of time within a time duration of a main discharge necessary for outputting pulse laser light with a desirable pulse energy.

The delay times T1 to T3 may have the following relation.

T1<T2<T3

In addition, among the initial values V0(T1) to V0(T3) of the apply voltage V, the initial value V0(T1) may have the largest absolute value. The initial value V0(T1) may be a voltage that at least enables dielectric breakdown of the laser gas between the pair of discharge electrodes 11.

At the end of the process in step S21, the laser controller 30 may proceed to step S22 of FIG. 7.

FIG. 9 is a flowchart illustrating a drive timing calculation process in step S23 of FIG. 7.

In step S2301, the laser controller 30 may make the same process as in step S301 of FIG. 5.

In step S2302, the laser controller 30 may determine whether the total charge voltage N·ΔV charged in capacitors C1 to CN by chargers 401 to 40N with identification numbers up to N is not more than the apply voltage V(T1).

If the total charge voltage N·ΔV is more than the apply voltage V(T1), the laser controller 30 may proceed to step S2305. Meanwhile, if the total charge voltage N·ΔV is not more than the apply voltage V(T1), the laser controller 30 may proceed to step S2303.

In step S2303, the laser controller 30 may determine the drive timing for the switch SWN with the identification number N.

The laser controller 30 may determine the drive timing for the switch SWN with the identification number N according to the following equation.

SWN=T1

In step S2304, the laser controller 30 may make the same process as in step S304 of FIG. 5.

Thereafter, the laser controller 30 may proceed to step S2302.

In step S2305, the laser controller 30 may determine a threshold number K1.

The threshold number K1 may be the identification number N that represents the border between activating primary electric circuits which are to be activated at a time point lagged by the delay time T1 from the oscillation trigger signal and other primary electric circuits among the “n” primary electric circuits 511 to 51n. Those primary electric circuits 511 to 51K1-1 which are in front stages before the border represented by the threshold number K1 may be primary electric circuits to be activated at the time point lagged by the delay time T1 from the oscillation trigger signal. Those primary electric circuits 51K1 to 51Nmax which are in rear stages behind the border represented by the threshold number K1 may be primary electric circuits not to be activated at the time point lagged by the delay time T1 from the oscillation trigger signal.

The threshold number K1 can be determined by the apply voltage V(T1) applied across the pair of discharge electrodes 11.

The laser controller 30 may determine the threshold number K1 according to the following equation:

K1=N

In step S2306, the laser controller 30 may determine whether the total charge voltage (N−K1+1)·ΔV charged in capacitors CK1 to CN by chargers 40K1 to 40N with identification numbers K1 to N is not more than the apply voltage V(T2).

If the total charge voltage (N−K1+1)·ΔV is more than the apply voltage V(T2), the laser controller 30 may proceed to step S2309. Meanwhile, if the total charge voltage (N−K1+1)·ΔV is not more than the apply voltage V(T2), the laser controller 30 may proceed to step S2307.

In step S2307, the laser controller 30 may determine the drive timing for the switch SWN with the identification number N.

The laser controller 30 may determine the drive timing for the switch SWN with the identification number N according to the following equation:

SWN=T2

In step S2308, the laser controller 30 may make the same process as in step S304 of FIG. 5.

Thereafter, the laser controller 30 may proceed to step S2306.

In step S2309, the laser controller 30 may determine a threshold number K2.

The threshold number K2 may be an identification number N that represents the border between activating primary electric circuits which are to be activated at a time point lagged by the delay time T2 from the oscillation trigger signal and other primary electric circuits among the primary electric circuits 51K1 to 51Nmax. Those primary electric circuits 51K1 to 51K2-1 which are in front stages before the border represented by the threshold number K2 may be primary electric circuits to be activated at the time point lagged by the delay time T2 from the oscillation trigger signal. Those primary electric circuits 51K2 to 51Nmax which are in rear stages behind the border represented by the threshold number K1 may be primary electric circuits not to be activated at the time point lagged by the delay time T2 from the oscillation trigger signal.

The threshold number K2 can be determined by the apply voltage V(T2) applied across the pair of discharge electrodes 11.

The laser controller 30 may determine the threshold number K2 according to the following equation:

K2=N

In step S2310, the laser controller 30 may determine whether the total charge voltage (N−K2+1)·ΔV charged in capacitors CK2 to CN by chargers 40K2 to 40N with identification numbers K2 to N is not more than the apply voltage V(T3).

If the total charge voltage (N−K2+1)·ΔV is more than the apply voltage V(T3), the laser controller 30 may proceed to step S2313. Meanwhile, if the total charge voltage (N−K2+1)·ΔV is not more than the apply voltage V(T3), the laser controller 30 may proceed to step S2311.

In step S2311, the laser controller 30 may determine the drive timing for the switch SWN with the identification number N.

The laser controller 30 may determine the drive timing for the switch SWN with the identification number N according to the following equation.

SWN=T3

In step S2312, the laser controller 30 may make the same process as in step S304 of FIG. 5.

Thereafter, the laser controller 30 may proceed to step S2310.

In step S2313, the laser controller 30 may determine a threshold number KN.

The threshold number KN may be an identification number N that represents the border between activating primary electric circuits which are to be activated at a time point lagged by the delay time T3 from the oscillation trigger signal and non-activating primary electric circuits among the primary electric circuits 51K2 to 51Nmax. Those primary electric circuits 51K2 to 51KN-1 which are in front stages before the border represented by the threshold number KN may be primary electric circuits to be activated at the time point lagged by the delay time T3 from the oscillation trigger signal. Those primary electric circuits 51KN to 51Nmax which are in rear stages behind the border represented by the threshold number KN may be primary electric circuits not to be activated.

The threshold number KN can be determined by the apply voltage V(T3) applied across the pair of discharge electrodes 11.

The laser controller 30 may determine the threshold number KN according to the following equation.

KN=N

In step S2314, the laser controller 30 may determine the drive timing for the switch SWN with the identification number N.

The switch SWN for which the drive timing is determined in step S2314 can be the switches SWKN to SWNmax with identification numbers N equal to or higher than the threshold number KN. The laser controller 30 may determine these switches SWN not to be activated.

The laser controller 30 may determine the drive timing for the switch SWN with the identification number N according to the following equation:

SWN=OFF

In step S2315, the laser controller 30 may make the same process as in step S307 of FIG. 5.

In step S2316, the laser controller 30 may determine whether or not the revised identification number N reaches or exceeds the maximum identification number Nmax.

If the revised identification number N is less than Nmax, the laser controller 30 may proceed to step S2314. Meanwhile, if the revised identification number N is Nmax or higher, the laser controller 30 may terminate the drive timing calculation process and produce the timing data, and then proceed to step S24 of FIG. 7.

Through these processes, the laser controller 30 can control the switches SW1 to SWK1-1 to be driven at the time point lagged by the delay time T1 from the oscillation trigger signal so as to generate the apply voltage V(T1) at the time point lagged by the delay time T1 from the oscillation trigger signal.

In addition, the laser controller 30 can control the switches SWK1 to SWK2-1 to be driven at the time point lagged by the delay time T2 from the oscillation trigger signal so as to generate the apply voltage V(T2) at the time point lagged by the delay time T2 from the oscillation trigger signal.

Furthermore, the laser controller 30 can control the switches SWK2 to SWKN-1 to be driven at the time point lagged by the delay time T3 from the oscillation trigger signal so as to generate the apply voltage V(T3) at the time point lagged by the delay time T3 from the oscillation trigger signal.

Meanwhile, the laser controller 30 can control so as not to drive the switches SWKN to SWNmax.

In other words, the laser controller 30 can produce such timing data that determines the switches SW1 to SWK1-1 to be activated at the time point lagged by the delay time T1 from the oscillation trigger signal. In addition, the laser controller 30 can produce such timing data that determines the switches SWK1 to SWK2-1 to be activated at the time point lagged by the delay time T2 from the oscillation trigger signal. Furthermore, the laser controller 30 can produce such timing data that determines the switches SWK2 to SWKN-1 to be activated at the time point lagged by the delay time T3 from the oscillation trigger signal. Moreover, the laser controller 30 can produce such timing data that determines the switches SWKN to SWNmax not to be activated.

Note that the time point lagged by the delay time T1 from the oscillation trigger signal, which is the drive timing for the switches SW1 to SWK1-1, may also be referred to as the first drive timing.

The time point lagged by the delay time T2 from the oscillation trigger signal, which is the drive timing for the switches SWK1 to SWK2-1, may also be referred to as the second drive timing.

The time point lagged by the delay time T3 from the oscillation trigger signal, which is the drive timing for the switches SWK2 to SWKN-1, may also be referred to as the third drive timing.

FIG. 10 is a flowchart illustrating a process for setting a new apply voltage V(t) in step S29 of FIG. 7.

In step S2901, the laser controller 30 may determine a new apply voltage V(T1) to be applied at the timing lagged by the delay time T1 from the oscillation trigger signal, so as to reduce the difference ΔE to be close to 0.

The laser controller 30 may determine the new apply voltage V(T1) according to the following equation:

V(T1)=V(T1)+α1·ΔE

In step S2902, the laser controller 30 may determine a new apply voltage V(T2) to be applied at the timing lagged by the delay time T2 from the oscillation trigger signal, so as to reduce the difference ΔE to be close to 0.

The laser controller 30 may determine the new apply voltage V(T2) according to the following equation:

V(T2)=V(T2)+α2·ΔE

In step S2903, the laser controller 30 may determine a new apply voltage V(T3) to be applied at the timing lagged by the delay time T3 from the oscillation trigger signal, so as to reduce the difference ΔE to be close to 0.

The laser controller 30 may determine the new apply voltage V(T3) according to the following equation:

V(T3)=V(T3)+α3·ΔE

Note that α1 to α3 may be constants of proportion predetermined by experiences and the like.

The values α1 to α3 may not have to be equal to each other.

In addition, among the apply voltages V(T1) to V(T3), the apply voltage V(T1) may have the largest absolute value. The apply voltage V(T1) may be a voltage that at least enables dielectric breakdown of the laser gas between the pair of discharge electrodes 11.

Insofar as the apply voltage V(T1) is such a voltage that at least enables dielectric breakdown of the laser gas between the pair of discharge electrodes 11, the constant α1 may be 0.

After the process in FIG. 10, the laser controller 30 may proceed to step S30 in FIG. 7.

FIG. 11 is a timing chart illustrating the operation of the high-voltage pulse generator of the second embodiment.

The laser controller 30 may output the timing data and the oscillation trigger signal to the switch driver section 60.

Upon the oscillation trigger signal being input, the switch driver section 60 may drive the switches SW1 to SWK1-1 at the time point lagged by the delay time T1 from the time of input of the oscillation trigger signal. The switch driver section 60 may drive the switches SWK1 to SWK2-1 at the time point lagged by the delay time T2 from the input time of the oscillation trigger signal. The switch driver section 60 may drive the switches SWK2 to SWKN-1 at the time point lagged by the delay time T3 from the input time of the oscillation trigger signal. The switch driver section 60 may not have to drive the switches SWKN to SWNmax.

The primary electric circuits 511 to 51K1-1 can be driven in synchronism with the drive timing for the switches SW1 to SWK1-1, respectively generating a voltage in a pulse waveform with a peak level at the charge voltage ΔV.

The primary electric circuits 51K1 to 51K2-1 can be driven in synchronism with the drive timing for the respective switches SWK1 to SWK2-1, respectively generating a voltage in a pulse waveform with a peak level at the charge voltage ΔV.

The primary electric circuits 51K2 to 51KN-1 can be driven in synchronism with the drive timing for the switches SWK2 to SWKN-1, respectively generating a voltage in a pulse waveform with a peak level at the charge voltage ΔV.

Meanwhile, the primary electric circuits 51KN to 51Nmax can remain inactive since the switches SWKN to SWNmax are not driven.

The secondary electric circuit 52 can generate the apply voltage V(T1) corresponding to the voltage Vs1(T1) which is a sum of voltages generated from the primary electric circuits 511 to 51K1-1 at the time point lagged by the delay time T1 from the input time of the oscillation trigger signal.

The secondary electric circuit 52 can generate the apply voltage V(T1) corresponding to the voltage Vs2(T2) which is a sum of voltages generated from the primary electric circuits 51K1 to 51K2-1 at the time point lagged by the delay time T2 from the input time of the oscillation trigger signal.

The secondary electric circuit 52 can generate the apply voltage V(T3) corresponding to the voltage Vs3(T3) which is a sum of voltages generated from the primary electric circuits 51K2 to 51KN-1 at the time point lagged by the delay time T3 from the input time of the oscillation trigger signal.

The absolute value of the maximum peak in the pulse waveforms of the voltages Vs1(t) to Vs3(t) can be (K1−1)·ΔV.

The apply voltage Vr(t) actually measured between the pair of discharge electrodes 11 can have a pulse waveform that approximately corresponds to a pulse waveform V(t) which is provided by overlapping the respective pulse waveforms of the voltages Vs1(t) to Vs3(t), except in regions immediately before and after the dielectric breakdown of the laser gas.

When a breakdown voltage Vb is applied across the pair of discharge electrodes 11, a main discharge occurs across the pair of discharge electrodes 11, and a current can flow from the second discharge electrode 11b to the first discharge electrode 11a. Then, even after the dielectric breakdown of the laser gas, the voltages Vs2(t) and Vs3(t) are applied across the pair of discharge electrodes 11, the main discharge occurring across the pair of discharge electrodes 11 can last longer than in the first embodiment.

The laser gas existing in the discharge space between the pair of discharge electrodes 11 is excited to emit light so that the gas laser apparatus 1 can output pulse laser light.

Other operations of the high-voltage pulse generator 5 of the second embodiment may be the same as those of the high-voltage pulse generator 5 of the first embodiment.

### 6.2 Effect

The high-voltage pulse generator 5 of the second embodiment can drive one group of the “n” switches SW1 to SWn at a particular drive timing and drive another group of the switches SW1 to SWn at a different drive timing from the particular drive timing.

Thereby, the high-voltage pulse generator 5 of the second embodiment can change the pulse waveform of the apply voltage V(t) applied across the pair of discharge electrodes 11 to an appropriate form.

As a result, the high-voltage pulse generator 5 of the second embodiment can control the pulse waveform of the apply voltage V(t) to be an optimum pulse waveform for obtaining the target pulse energy Et.

Also, the high-voltage pulse generator 5 of the second embodiment can actively control the pulse waveform of the apply voltage V(t). This means that the high-voltage pulse generator 5 of the second embodiment can control the pulse waveform of the apply voltage V(t) even after a main discharge occurs across the pair of discharge electrodes 11. It means that the high-voltage pulse generator 5 of the second embodiment can control the amount of energy applied to the pair of discharge electrodes 11 even after the occurrence of the main discharge.

Therefore, the high-voltage pulse generator 5 of the second embodiment is capable of making the energy applied to the pair of discharge electrodes 11 still more efficiently contribute to the laser oscillation, achieving a further improvement in the oscillation efficiency of pulse laser light.

In addition, the high-voltage pulse generator 5 of the second embodiment can control the intensity and time of the discharge current flowing across the pair of discharge electrodes 11 by changing the number of activating switches SW so as to change the pulse waveform of the apply voltage V(t). Thereby, the high-voltage pulse generator 5 of the second embodiment can control the pulse waveform of the output pulse laser light.

In the illustrated example, the high-voltage pulse generator 5 of the second embodiment determines the drive timing for the “n” switches SW1 to SWn by means of three delay times T1 to T3, but it is possible to adopt two delay times or more than three delay times instead. With an increased number of delay times, it is possible to more accurately control the pulse waveform of the apply voltage Vr(t) which is actually measured between the pair of discharge electrodes 11.

In addition, the high-voltage pulse generator 5 of the second embodiment can change the apply voltages V(T1) to V(T3) individually by changing the number of activating switches SW, as appropriate.

However, the high-voltage pulse generator 5 of the second embodiment may, for example, determine the apply voltage V(T1) to be a constant voltage that enables dielectric breakdown of the laser gas between the pair of discharge electrodes 11. Then, the apply voltages V(T2) and V(T3) may be changed by changing the number of switches SW to be activated therefor. Thus, the high-voltage pulse generator 5 of the second embodiment may control the amount of energy applied to the pair of discharge electrodes 11.

### 7. High-Voltage Pulse Generator of Third Embodiment

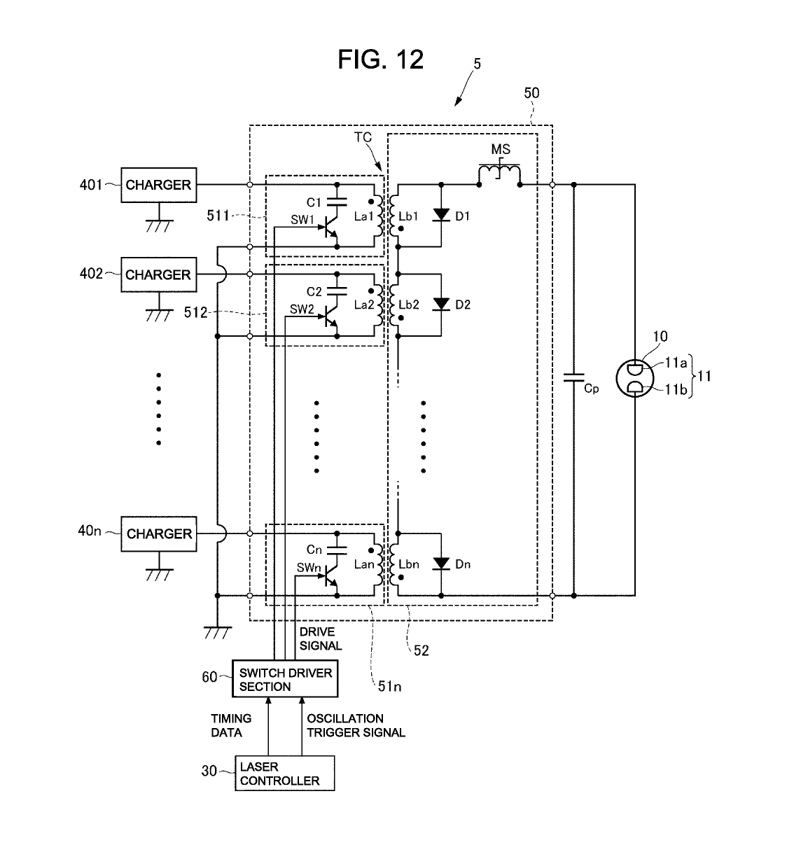

Referring to FIG. 12, a high-voltage pulse generator 5 of a third embodiment will be described.

The high-voltage pulse generator 5 of the third embodiment may be provided with a peaking capacitor Cp and a magnetic switch MS in addition to the features of the high-voltage pulse generator 5 of the first embodiment.

Regarding a gas laser apparatus 1 provided with the high-voltage pulse generator 5 of the third embodiment, the description of the same features and operations as the gas laser apparatus 1 provided with the high-voltage pulse generator 5 of the first embodiment will be omitted.

FIG. 12 is a diagram illustrating a configuration of the high-voltage pulse generator 5 according to the third embodiment.

The peaking capacitor Cp shown in FIG. 12 may have the same configuration as the peaking capacitor Cp shown in FIG. 2.

The peaking capacitor Cp may be connected in parallel to and between a secondary electric circuit 52 and a pair of discharge electrodes 11. The peaking capacitor Cp may be connected in parallel to and between a number “n” of secondary coils Lb1 to Lbn and the pair of discharge electrodes 11.

The secondary electric circuit 52 shown in FIG. 12 may include a magnetic switch MS.

The magnetic switch MS may have the same configuration as the magnetic switches MS1 to MS3 shown in FIG. 2.

The magnetic switch MS may be connected in series between the “n” secondary coils Lb1 to Lbn and the pair of discharge electrodes 11. The magnetic switch MS may be connected in series between the “n” secondary coils Lb1 to Lbn and the peaking capacitor Cp.

Other features of the high-voltage pulse generator 5 of the third embodiment may be the same as those of the high-voltage pulse generator 5 of the first embodiment.

According to the above-described configuration, the high-voltage pulse generator 5 of the third embodiment can further compress the pulse of voltage generated through the “n” secondary coils Lb1 to Lbn in a magnetic compression circuit constituted of the peaking capacitor Cp and the magnetic switch MS. Then, the high-voltage pulse generator 5 of the third embodiment can apply the voltage after the pulse compression through the magnetic compression circuit as an apply voltage V across the pair of discharge electrodes 11.

Thus, even while the respective voltages generated from the “n” primary electric circuits 511 to 51n have long pulse widths, the high-voltage pulse generator 5 of the third embodiment can compress the pulses through the magnetic compression circuit and thus apply a voltage V as a high-voltage short-width pulse to the pair of discharge electrodes 11.

Although the high-voltage pulse generator 5 of the third embodiment is provided with both the peaking capacitor Cp and the magnetic switch MS in the illustrated example, it is possible to be provided only with the peaking capacitor Cp.

### 8. High-Voltage Pulse Generator of Fourth Embodiment

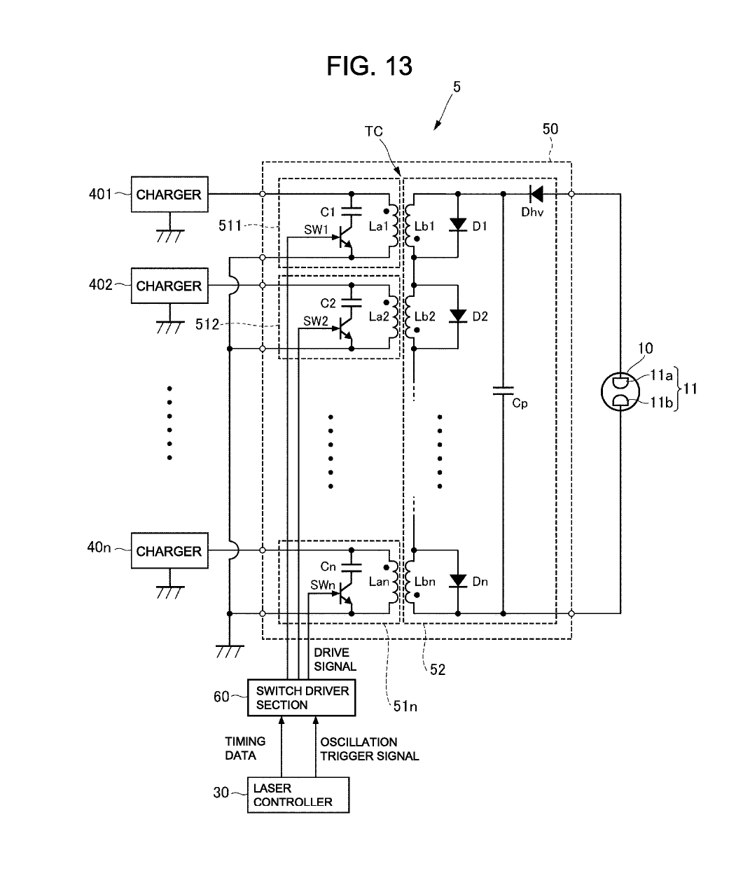

Referring to FIG. 13, a high-voltage pulse generator 5 according to a fourth embodiment will be described.

The high-voltage pulse generator 5 of the fourth embodiment may be provided with a peaking capacitor Cp and a high withstand voltage diode Dhv in addition to the features of the high-voltage pulse generator 5 of the first embodiment.

Regarding a gas laser apparatus 1 provided with the high-voltage pulse generator 5 of the fourth embodiment, the description of the same features and operations as the gas laser apparatus 1 provided with the high-voltage pulse generator 5 of the first embodiment will be omitted.

FIG. 13 is a diagram illustrating a configuration of the high-voltage pulse generator 5 according to the fourth embodiment.

A secondary electric circuit 52 shown in FIG. 13 may include the peaking capacitor Cp and the high withstand voltage diode Dhv.

The peaking capacitor Cp may have the same configuration as the peaking capacitor Cp shown in FIG. 2.

The peaking capacitor Cp may be connected in parallel to and between a number “n” of secondary coils Lb1 to Lbn and a pair of discharge electrodes 11.

The high withstand voltage diode Dhv may be a diode that prevents a reverse current flowing from the pair of discharge electrodes 11 to the peaking capacitor Cp.

The high withstand voltage diode Dhv may be formed form a semiconductor material, such as SiC.

The high withstand voltage diode Dhv may be connected in serial between the peaking capacitor Cp and the pair of discharge electrodes 11. The high withstand voltage diode Dhv may be connected in an orientation that prevents the reverse current flowing from the pair of discharge electrodes 11 to the peaking capacitor Cp.

Other features of the high-voltage pulse generator 5 of the fourth embodiment may be the same as those of the high-voltage pulse generator 5 of the first embodiment.

According to the configuration above, the high-voltage pulse generator 5 of the fourth embodiment, being provided with the high withstand voltage diode Dhv, can prevent occurrence of the reverse current while the voltage V is being applied across the pair of discharge electrodes 11.

Thus, the high-voltage pulse generator 5 of the fourth embodiment can prevent an abnormal arc discharge that may occur across the pair of discharge electrodes 11.

As a result, the high-voltage pulse generator 5 of the fourth embodiment can stabilize the pulse energy of pulse laser light.

Incidentally, because the high-voltage pulse generator 5 of the fourth embodiment is provided with the high withstand voltage diode Dhv and thus capable of preventing the reverse current, it is possible to eliminate the “n” diodes D1 to Dn.

In the high-voltage pulse generator 5 of the fourth embodiment, the high withstand voltage diode Dhv may be constituted of multiple diodes which are connected in parallel to one another, in place of a single diode.

In the high-voltage pulse generator 5 of the fourth embodiment, the high withstand voltage diode Dhv may be connected in series between the peaking capacitor Cp and the diode D1 in an orientation against the reverse current from the pair of discharge electrodes 11.

### 9. High-Voltage Pulse Generator of Fifth Embodiment

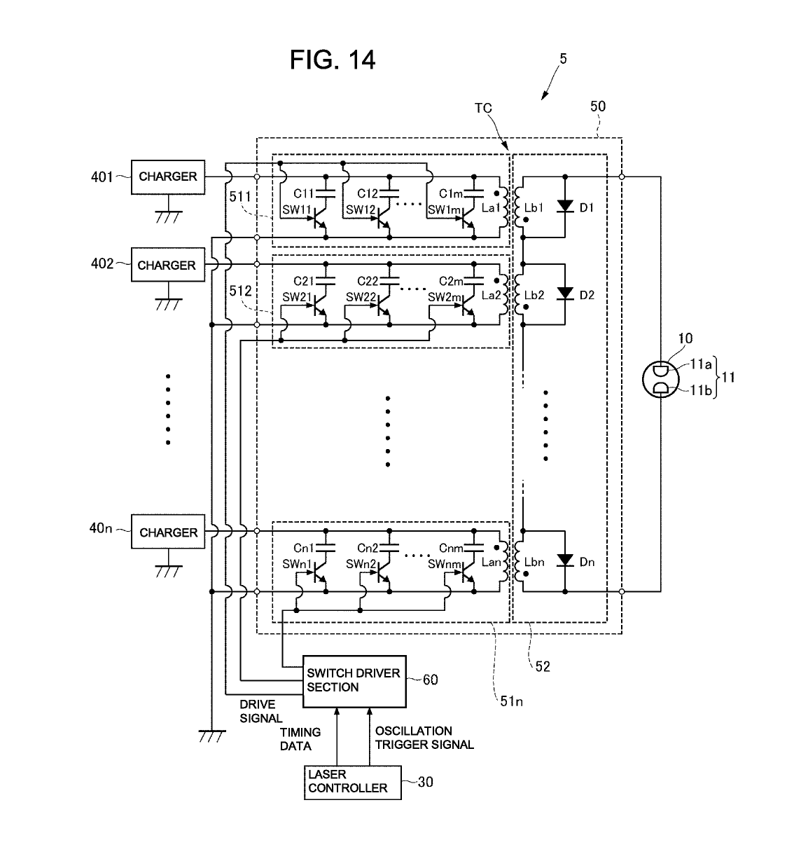

Referring to FIG. 14, a high-voltage pulse generator 5 of a fifth embodiment will be described.

In the high-voltage pulse generator 5 of the fifth embodiment, each of a number “n” of primary electric circuits 511 to 51n may include multiple capacitors and multiple switches SW.

Concerning a gas laser apparatus 1 provided with the high-voltage pulse generator 5 of the fifth embodiment, the description of the same features and operations as the gas laser apparatus 1 provided with the high-voltage pulse generator 5 of the first embodiment will be omitted.

FIG. 14 is a diagram illustrating a configuration of the high-voltage pulse generator 5 according to the fifth embodiment.

Each of the “n” primary electric circuits 511 to 51n shown in FIG. 14 may include a number “m” of capacitors C and a number “m” of switches SW, wherein “m” may be a natural number of not less than 2.

In other words, the “m” capacitors C in the high-voltage pulse generator 5 of the fifth embodiment may constitute each of the “n” capacitors C1 to Cn as included in the high-voltage pulse generator 5 of the first embodiment. Likewise, in the high-voltage pulse generator 5 of the fifth embodiment, the “m” switches SW may constitute each of the “n” switches SW1 to SWn as included in the high-voltage pulse generator 5 of the first embodiment.

For example, the first stage primary electric circuit 511 on the top side in FIG. 14 may include a number “m” of capacitors C11 to C1m and a number “m” of switches SW11 to SW1m.

The “m” capacitors C11 to C1m may be connected in parallel to one another.

The “m” capacitors C11 to C1m may be connected in parallel to a primary coil La1.

The “m” capacitors C11 to C1m may be individually connected at one terminals thereof to a wire that interconnects the primary coil La1 with a charger 401.

The “m” capacitors C11 to C1m may be connected at the other terminals thereof to the “m” switches SW11 to SW1m, respectively.

The “m” switches SW11 to SW1m may be connected in series to the “m” capacitors C11 to C1m, respectively.

One ends of the “m” switches SW11 to SW1m may be connected to the “m” capacitors C11 to C1m, respectively.

The other ends of the “m” switches SW11 to SW1m may be connected to a wire that connects the primary coil La1 to the ground.

In addition, the “m” switches SW11 to SW1m may be individually connected to the switch driver section 60. The “m” switches SW11 to SW1m may be driven under the control of the switch driver section 60.

The switch driver section 60 may control driving each of the “m” switches SW11 to SW1m at approximately the same drive timing.

The “m” capacitors C and the “m” switches SW included in the primary electric circuits 512 to 51n of other stages shown in FIG. 14 may have the same configuration as the “m” capacitors C11 to C1m and the “m” switches SW11 to SW1m included in the first stage primary electric circuit 511.

Other features of the high-voltage pulse generator 5 of the fifth embodiment may be the same as those of the high-voltage pulse generator 5 of the first embodiment.

According to the above-described configuration of the high-voltage pulse generator 5 of the fifth embodiment, each of the “n” primary electric circuits 511 to 51n includes the “m” capacitors C and the “m” switches SW, and each of the “m” switches SW can be driven at approximately the same drive timing.

Thereby, each primary electric circuit of the high-voltage pulse generator 5 of the fifth embodiment, for instance, the primary electric circuit 511 can generate a voltage in a pulse waveform with a narrower pulse width in comparison with the primary electric circuit 511 involved in first embodiment.

As a result, the high-voltage pulse generator 5 of the fifth embodiment can control the pulse waveform of the apply voltage V applied across the pair of discharge electrodes 11 with high accuracy so as to provide a more suitable pulse waveform.

Therefore, the high-voltage pulse generator 5 of the fifth embodiment can further improve the oscillation efficiency for the pulse laser light.

### 10. High-Voltage Pulse Generator of Sixth Embodiment

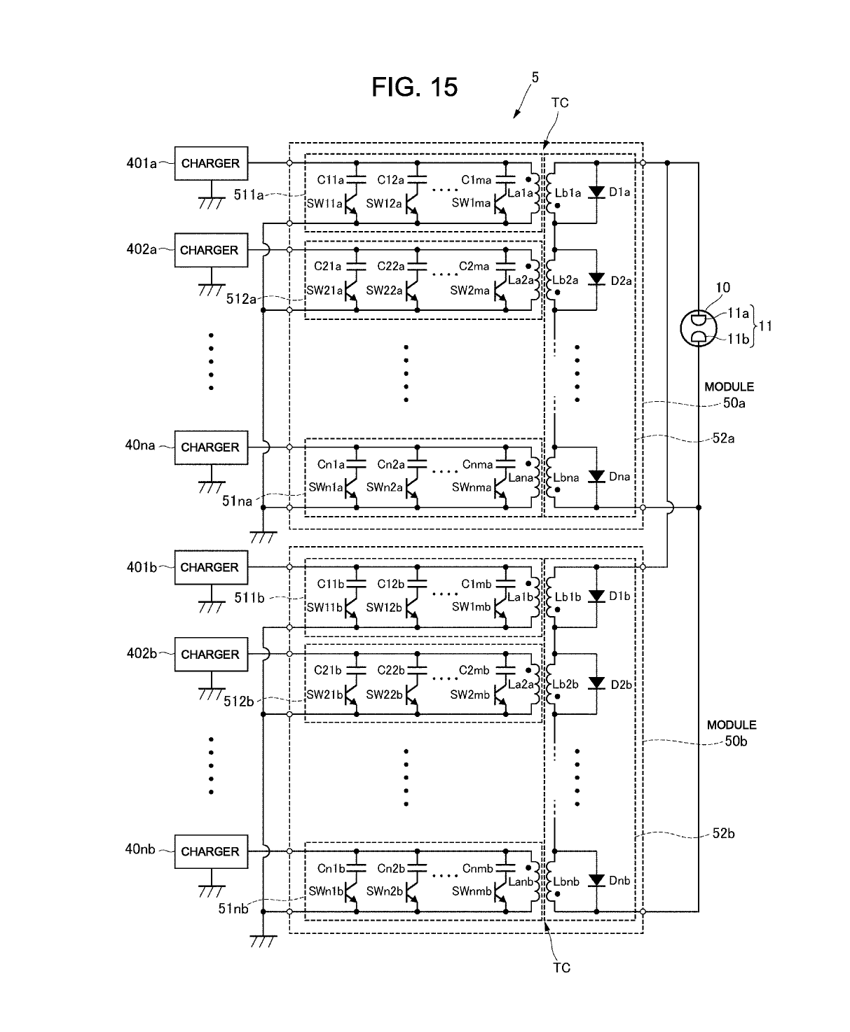

Referring to FIG. 15, a high-voltage pulse generator 5 of a sixth embodiment will be described.

FIG. 15 is a diagram illustrating a configuration of the high-voltage pulse generator 5 according to the sixth embodiment.

The high-voltage pulse generator 5 of the sixth embodiment may be provided with multiple modules which are connected in parallel to each other, each module including the “n” primary electric circuits 511 to 51n and a secondary electric circuit 52 involved in the fifth embodiment.

In addition, the high-voltage pulse generator 5 of the sixth embodiment may have a configuration in which each of the multiple modules is individually connected to a number “n” of chargers 401 to 40n.

FIG. 15 shows an example in which a module 50a including a number “n” of primary electric circuits 511a to 51na and a secondary electric circuit 52a and a module 50b including a number “n” of primary electric circuits 511b to 51nb and a secondary electric circuit 52b are connected in parallel.

Furthermore, in the example of FIG. 15, the “n” primary electric circuits 511a to 51na included in the module 50a are connected to a number “n” of chargers 401a to 40na, respectively, and the “n” primary electric circuits 511b to 51nb included in the module 50b are connected to a number “n” of chargers 401b to 40nb, respectively.

Note that the laser controller 30 and the switch driver section 60 are omitted from the drawing in FIG. 15.

Other features of the high-voltage pulse generator 5 of the sixth embodiment may be the same as those of the high-voltage pulse generator 5 of the fifth embodiment.

According to the above-described configuration, the high-voltage pulse generator 5 of the sixth embodiment can enhance the pulse energy of pulse laser light in comparison with the high-voltage pulse generator 5 of the fifth embodiment.

### 11. High-Voltage Pulse Generator of Seventh Embodiment

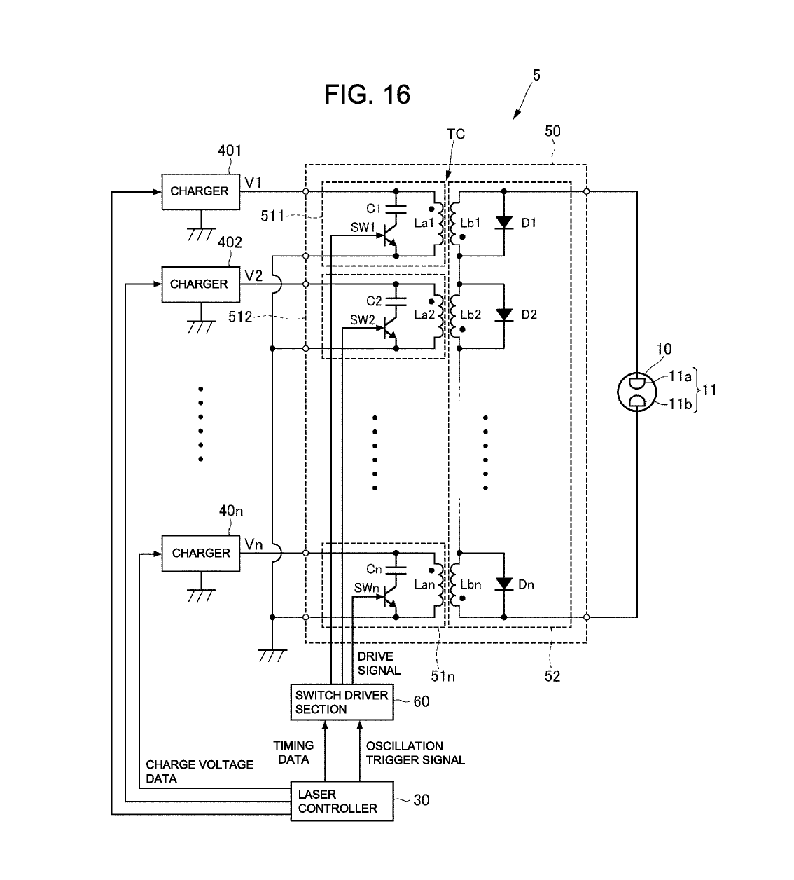

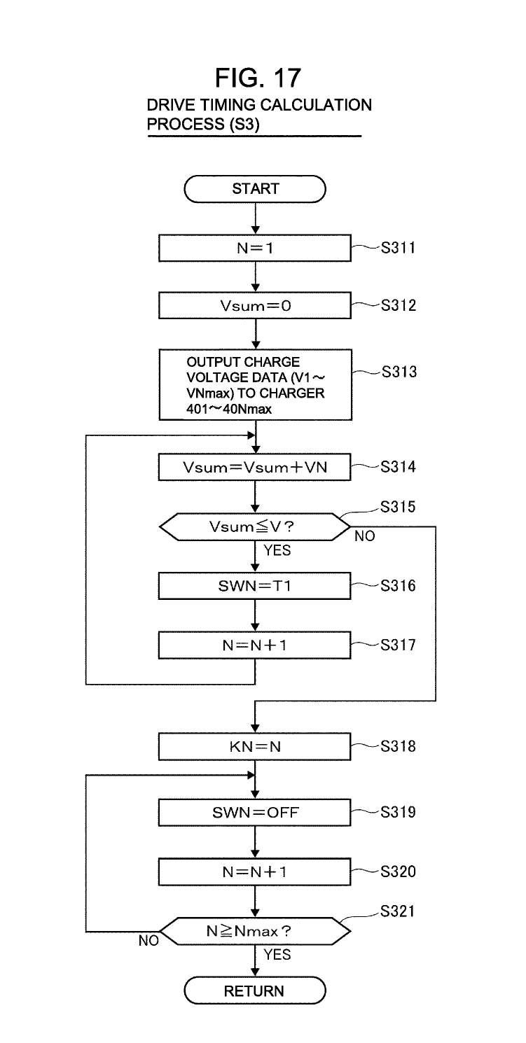

Referring to FIG. 16 and FIG. 17, a high-voltage pulse generator 5 of a seventh embodiment will be described.

In the high-voltage pulse generator 5 of the first embodiment, the “n” chargers 401 to 40n may charge the “n” capacitors C1 to Cn at an approximately equal charge voltage ΔV.

Meanwhile, in the high-voltage pulse generator 5 of the seventh embodiment, a number “n” of chargers 401 to 40n may charge a number “n” of capacitors C1 to Cn at different charge voltages V1 to Vn from each other.

Concerning a gas laser apparatus 1 provided with the high-voltage pulse generator 5 of the seventh embodiment, the description of the same features and operations as the gas laser apparatus 1 provided with the high-voltage pulse generator 5 of the first embodiment will be omitted.

FIG. 16 is a diagram illustrating a configuration of the high-voltage pulse generator 5 according to the seventh embodiment.

The laser controller 30 shown in FIG. 16 may produce charge voltage data that determines individual values of the charge voltages V1 to Vn to be charged in the “n” capacitors C1 to Cn by the “n” chargers 401 to 40n, respectively, and may output the charge voltage data to the “n” chargers 401 to 40n.

The values of the charge voltages V1 to Vn may be determined as appropriate insofar as these values can provide a charge voltage necessary for generating an apply voltage V to be applied across the pair of discharge electrodes 11.

The laser controller 30 may produce and output the charge voltage data only for those chargers 40 which are served for generating the apply voltage V among the “n” chargers 401 to 40n.

The “n” chargers 401 to 40n may charge the “n” capacitors C1 to Cn at the charge voltages V1 to Vn based on the charge voltage data.

Other features of the high-voltage pulse generator 5 of the seventh embodiment may be the same as those of the high-voltage pulse generator 5 of the first embodiment.

FIG. 17 is a flowchart illustrating the drive timing calculation process performed by the laser controller 30 involved in the seventh embodiment.

The laser controller 30 involved in the seventh embodiment may perform the drive timing calculation process shown in FIG. 17 in step S3 of FIG. 4, instead of the drive timing calculation process shown in FIG. 5.

In step S311, the laser controller 30 may make the same process as in step S301 of FIG. 5.

In step S312, the laser controller 30 may reset the sum Vsum of charge voltages V1 to VN charged in capacitors C1 to CN by chargers 401 to 40N, which are provided with identification numbers up to N.

The laser controller 30 may reset the sum Vsum according to the following equation:

Vsum=0

In step S313, the laser controller 30 may output the charge voltage data to those chargers 401 to 40Nmax which are served for generating the apply voltage V.

The charge voltage data output to the chargers 401 to 40Nmax may determine respective values of the charge voltages V1 to VNmax to be charged by the chargers 401 to 40Nmax into the capacitors C1 to CNmax.

In step S314, the laser controller 30 may revise the sum Vsum using the charge voltage VN charged in the capacitor CN by the charger 40N, which are provided with an identification number N.

The laser controller 30 may revise the sum Vsum according to the following equation:

Vsum=Vsum+VN

In step S315, the laser controller 30 may determine whether the sum Vsum is not greater than the apply voltage V to be applied across the pair of discharge electrodes 11.

If the sum Vsum is greater than the apply voltage V, the laser controller 30 may proceed to step S318. Meanwhile, if the sum Vsum is not greater than the apply voltage V, the laser controller 30 may proceed to step S316.

In step S316, the laser controller 30 may make the same process as in step S303 of FIG. 5.

In step S317, the laser controller 30 may make the same process as in step S304 of FIG. 5.

Thereafter, the laser controller 30 may proceed to step S314.

In step S318 to S320, the laser controller 30 may make the same processes as in steps S305 to S307 of FIG. 5.

In step S321, the laser controller 30 may determine whether or not the revised identification number N reaches or exceeds the maximum identification number Nmax.

If the revised identification number N is less than Nmax, the laser controller 30 may proceed to step S319. If the revised identification number N is Nmax or higher, the laser controller 30 may terminate the drive timing calculation process and produce the timing data, and then proceed to step S4 of FIG. 4.

Through these processes, the laser controller 30 can control the chargers 401 to 40Nmax, which are served for generating the apply voltage V, to perform charging at respective charge voltages V1 to VNmax.

The laser controller 30 can drive only the switches SW1 to SWKN-1 if the necessary apply voltage V can be generated by supplying the primary coils La1 to LaKN-1 with a current corresponding to the sum Vsum of charge voltages V1 to VKN-1 charged in the capacitors C1 to CKN-1.

Consequently, the laser controller 30 can drive the switches SW1 to SWKN-1 depending on the sum Vsum of charge voltages V1 to VKN-1 so as to generate the necessary apply voltage V also while the capacitors C1 to CNmax are being charged at different charge voltages V1 to VNmax from each other.

The laser controller 30 can produce timing data that determines to drive the switches SW1 to SWKN-1 at the timing lagged by a delay time T1 from the oscillation trigger signal according to the sum Vsum of charge voltages V1 to VKN-1 which is capable of generating the necessary apply voltage V. In addition, the laser controller 30 can produce timing data that determines not to drive the switches SWKN to SWNmax.

Other operations of the high-voltage pulse generator 5 of the seventh embodiment may be the same as those of the high-voltage pulse generator 5 of the first embodiment.

The above-described configuration of the high-voltage pulse generator 5 of the seventh embodiment makes it possible to use such charge voltages V1 to Vn that can take appropriate values to generate the apply voltage V applied across the pair of discharge electrodes 11, whereas the apply voltage can only be an integral number of times of a charge voltage ΔV in the high-voltage pulse generator 5 of the first embodiment.

Accordingly, the high-voltage pulse generator 5 of the seventh embodiment can control the pulse waveform of the apply voltage V to be a still more suitable pulse waveform in comparison with the high-voltage pulse generator 5 of the first embodiment.

As a result, the high-voltage pulse generator 5 of the seventh embodiment can control the pulse energy of output pulse laser light more accurately in comparison with the high-voltage pulse generator 5 of the first embodiment.

Therefore, as compared to the high-voltage pulse generator 5 of the first embodiment, the high-voltage pulse generator 5 of the seventh embodiment can further improve the oscillation efficiency for the pulse laser light.

Note that, the high-voltage pulse generator 5 of the seventh embodiment may control the apply voltage V by driving all switches SW1 to SWn and changing every voltage charged by all chargers 401 to 40N so as to reduce the difference ΔE between the measured pulse energy value E and the target pulse energy Et to be close to 0.

### 12. High-Voltage Pulse Generator of Eighth Embodiment

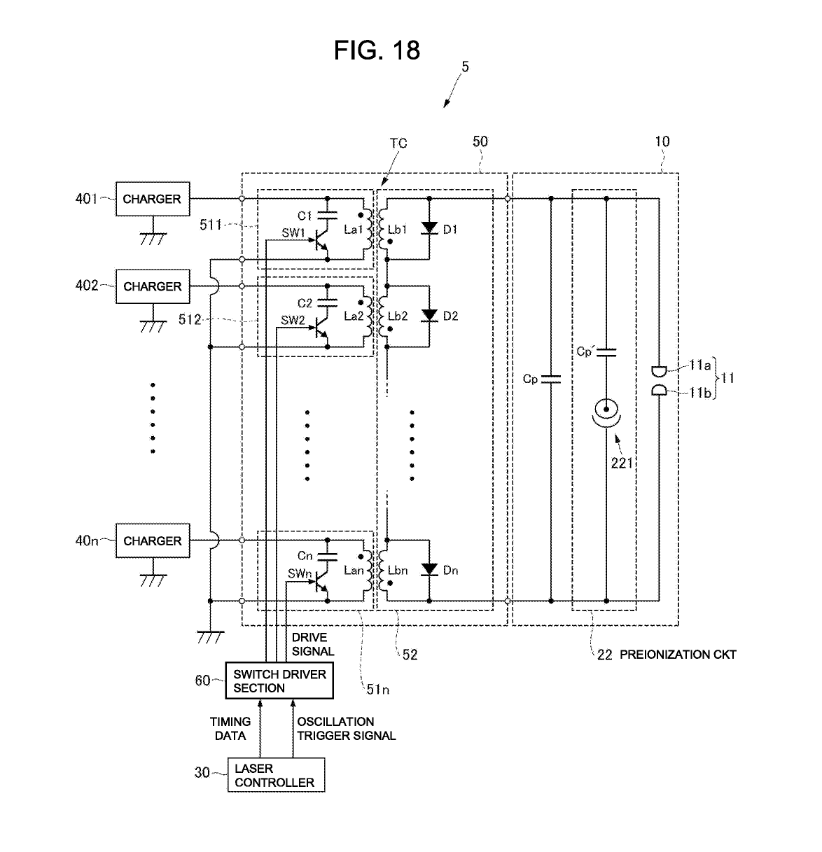

Using FIG. 18 to FIG. 20, a high-voltage pulse generator 5 of the eighth embodiment will be described.

The high-voltage pulse generator 5 of the eighth embodiment may be provided with a preliminary ionization circuit 22 and a peaking capacitor Cp in addition to the high-voltage pulse generator 5 of the first embodiment. Furthermore, in the high-voltage pulse generator 5 of the eighth embodiment, a number “n” of switches SW1 to SWn included in a number “n” of primary electric circuits 511 to 51n may be constituted of two or more kinds of semiconductor switches in combination.

Regarding a gas laser apparatus 1 provided with the high-voltage pulse generator 5 of the eighth embodiment, the description of the same features and operations as the gas laser apparatus 1 provided with the high-voltage pulse generator 5 of the first embodiment will be omitted.

### 12.1 Configuration

FIG. 18 is a diagram illustrating a configuration of the high-voltage pulse generator 5 according to the eighth embodiment.

The preliminary ionization circuit 22 shown in FIG. 18 may include preliminary ionization electrodes 221 and a preliminary ionization capacitor Cp′.

The preliminary ionization electrodes 221 may be an electrode for preliminary ionization of a laser gas between a pair of discharge electrodes 11 in a preliminary stage for a main discharge. As described above, the main discharge can be caused by dielectric breakdown of the laser gas between the pair of discharge electrodes 11.

The preliminary ionization electrodes 221 and the preliminary ionization capacitor Cp′ may be located inside a laser chamber 10. Alternatively, the preliminary ionization capacitor Cp′ may be disposed outside the laser chamber 10 via a not-shown feedthrough.

The preliminary ionization electrodes 221 and the preliminary ionization capacitor Cp′ may be connected in serial to each other.

The preliminary ionization electrodes 221 and the preliminary ionization capacitor Cp′ may be connected in parallel to and between a secondary electric circuit 52 and the pair of discharge electrodes 11. The preliminary ionization electrodes 221 and the preliminary ionization capacitor Cp′ may be connected in parallel to and between a peaking capacitor Cp and the pair of discharge electrodes 11.

The preliminary ionization circuit 22 may serve as a voltage divider circuit for dividing the voltage applied across the pair of discharge electrodes 11.

The range of voltage division may be from 25% to 75% of the voltage applied across the pair of discharge electrodes 11. The divided voltage may be applied to the preliminary ionization electrodes 221.

The time constant of the preliminary ionization circuit 22 can be adjusted to a desirable value by controlling the capacity of the preliminary ionization capacitor Cp′ and the like. Thereby, the timing of preliminary ionization for the main discharge can be controlled. The combined capacity in the preliminary ionization circuit 22 may be adjusted to 10% or less of the capacity of the peaking capacitor Cp.

When a voltage is applied to the preliminary ionization electrodes 221, a preliminary ionization discharge can occur across the preliminary ionization electrodes 221. The preliminary ionization discharge can be a corona discharge occurring on the surface of a not-shown dielectric substance that is disposed within the preliminary ionization electrodes 221. UV (Ultraviolet) light generated by the corona discharge can cause preliminary ionization of the laser gas between the pair of discharge electrodes 11.

The peaking capacitor Cp shown in FIG. 18 may have the same configuration as the peaking capacitor Cp shown in FIG. 2.

The peaking capacitor Cp may be located within the laser chamber 10.

The peaking capacitor Cp may be connected in parallel to and between the secondary electric circuit 52 and the preliminary ionization circuit 22.

The “n” switches SW1 to SWn included in the “n” primary electric circuits 511 to 51n shown in FIG. 18 may be constituted of a combination of two or more kinds of semiconductor switches.

The kinds of semiconductor switches constituting the “n” switches SW1 to SWn may be sorted according to the switching speed thereof. Namely, one part of the “n” switches SW1 to SWn may be constituted of first semiconductor switches that operate at a first switching speed. In addition, another part of the “n” switches SW1 to SWn may be constituted of second semiconductor switches that operate at a second switching speed faster than the first switching speed.

Alternatively, the kinds of semiconductor switches constituting the “n” switches SW1 to SWn may be sorted according to the current capacity thereof. Namely, one part of the “n” switches SW1 to SWn may be constituted of first semiconductor switches having a first current capacity. In addition, another part of the “n” switches SW1 to SWn may be constituted of second semiconductor switches having a second current capacity that is smaller than the first current capacity.

The semiconductor switches constituting the “n” switches SW1 to SWn may be a power device using Si as a semiconductor material, such as MOSFET (metal-oxide-semiconductor field-effect transistor) and IGBT (insulated gate bipolar transistor). In an alternative example, the semiconductor switches constituting the “n” switches SW1 to SWn may be a power device using GaN, 4H—SiC, β-Ga₂O₃ or the like as a semiconductor material.

The number of kinds of semiconductor switches constituting the “n” switches SW1 to SWn shown in FIG. 18 is not particularly limited but at least 2.

Incidentally, MOSFET has a property enabling a faster switching speed than IGBT. Therefore, MOSFET is suitable as a semiconductor switch addressed to achieve narrowing the pulse width of the apply voltage V applied across the pair of discharge electrodes 11 and applying the apply voltage V across the pair of discharge electrodes 11 within a short moment.

Meanwhile, IGBT can have a property of providing a greater current capacity than MOSFET. Therefore, IGBT is suitable as a semiconductor switch addressed to achieve supplying energy necessary for causing and continuing the main discharge.

Among the semiconductor switches constituting the “n” switches SW1 to SWn shown in FIG. 18, the aforementioned first semiconductor switch may be IGBT, whereas the aforementioned second semiconductor switch may be MOSFET.

In addition, a switch driver section 60 shown in FIG. 18 may control driving the “n” switches SW1 to SWn on the basis of timing data and an oscillation trigger signal in the same way as the switch driver section 60 involved in the first embodiment shown FIG. 3.

The timing data may include at least information determining to drive the first semiconductor switch at a drive timing corresponding to the time of occurrence of the preliminary ionization. In addition, the timing data may include at least information determining to drive the second semiconductor switch at a drive timing corresponding to the time of occurrence of the main discharge.

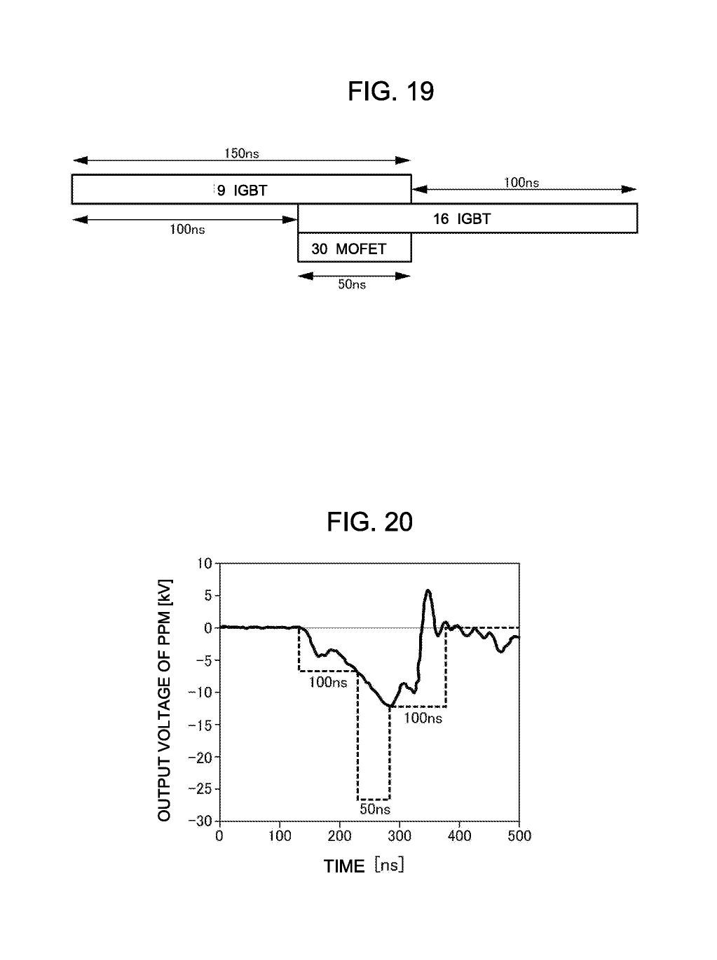

FIG. 19 is a diagram illustrating the timing data input to the switch driver section 60 shown in FIG. 18, as well as an example of combination of different kinds of semiconductor switches constituting the “n” switches SW1 to SWn and the drive timing therefor.

In the example shown in FIG. 19, the “n” switches SW1 to SWn are constituted of the following combination of switches: nine switches SW1 to SW9 included in the primary electric circuits 511 to 519 of the first to ninth stages are composed of IGBTs, and 16 switches SW10 to SW25 included in the primary electric circuits 5110 to 5125 of the tenth to twenty-fifth stages are composed of IGBTs, whereas 31 switches SW26 to SW56 included in the primary electric circuits 5126 to 5156 of the twenty-sixth to fifty-sixth stages are composed of MOSFETs.

In addition, the example of FIG. 19 indicates that the “n” switches SW1 to SWn are determined to be driven at the following drive timing. That is, in the example of FIG. 19, the nine switches SW1 to SW9 composed of IGBTs are driven first, and in 100 ns after the time of driving the switches SW1 to SW9, the 16 switches SW10 to SW25 composed of IGBTs and the 31 switches SW26 to SW56 composed of MOSFETs are driven. Furthermore, in the example of FIG. 19, the switches SW1 to SW9 and the switches SW26 to SW56 stop being driven in 50 ns from the start of driving the switches SW10 to SW25 and the switches SW26 to SW56. Moreover, in the example of FIG. 19, the switches SW10 to SW25 stop being driven in 100 ns after the stop of driving the switches SW1 to SW9 and the switches SW26 to SW56.

Other features of the high-voltage pulse generator 5 of the eighth embodiment may be the same as those of the high-voltage pulse generator 5 of the first embodiment.

### 12.2 Operation

FIG. 20 is a diagram illustrating a voltage output from the pulse power module 50 shown in FIG. 18, while the “n” switches SW1 to SWn composed of the combination of semiconductor switches shown in FIG. 19 are being driven at the drive timing shown in FIG. 19.

A solid line in FIG. 20 shows a waveform of a voltage actually measured as the output voltage from the pulse power module 50. A dashed line in FIG. 20 shows a target voltage in controlling the output voltage from the pulse power module 50, the target voltage corresponding to the combination of semiconductor switches and the drive timing in the example shown in FIG. 19.

When the oscillation trigger signal is input, the switch driver section 60 may drive the nine switches SW1 to SW9 composed of IGBTs.

Then, a voltage necessary for the preliminary ionization discharge is applied to the preliminary ionization circuit 22, enabling the preliminary ionization of the laser gas between the pair of discharge electrodes 11.

In 100 ns after the drive timing for the switches SW1 to SW9, the switch driver section 60 may drive the 16 switches SW10 to SW25 composed of IGBTs and the 30 switches SW26 to SW56 composed of MOSFETs.

Thus, the peaking capacitor Cp is charged, and a pulse-shaped high voltage necessary for the main discharge is applied across the pair of discharge electrodes 11. As the peaking capacitor Cp is temporarily charged, the output voltage from the pulse power module 50 can have an increased peak level as well as a reduced pulse width and thus become the pulse-shaped high voltage necessary for the main discharge.

When the voltage applied across the pair of discharge electrodes 11 exceeds the breakdown voltage of the laser gas, the laser gas can dielectrically break down, causing the main discharge across the pair of discharge electrodes 11.

In 50 ns after the drive timing for the switches SW10 to SW25 and the switches SW26 to SW56, the switch driver section 60 may stop driving the switches SW1 to SW9 and switches SW26 to SW56. Meanwhile, the switch driver section 60 may drive the switches SW10 to SW25 for 100 ns after the deactivation of the switches SW1 to SW9 and the switches SW26 to SW56.

Thus, the output voltage from the pulse power module 50 can be applied across the pair of discharge electrodes 11 at such magnitude and time that the main discharge occurring across the pair of discharge electrodes 11 lasts for a suitable length.

The main discharge occurring across the pair of discharge electrodes 11 can last for such a length that permits exciting the laser gas to perform the laser oscillation suitably.

Other operations of the high-voltage pulse generator 5 of the eighth embodiment may be the same as those of the high-voltage pulse generator 5 of the first embodiment.

### 12.3 Effect

In the high-voltage pulse generator 5 of the eighth embodiment, the “n” switches SW1 to SWn included in the “n” primary electric circuits 511 to 51n can be constituted of a combination of two or more kinds of semiconductor switches which differ at least in switching speed or current capacity from each other.

This configuration of the high-voltage pulse generator 5 of the eighth embodiment makes it possible to drive the “n” switches SW1 to SWn in such a combination of semiconductor switches at such drive timing that is optimum for causing the main discharge and the preliminary ionization discharge.

In other words, the high-voltage pulse generator 5 of the eighth embodiment can control the pulse waveforms of respective voltages applied to the preliminary ionization circuit 22 and the pair of discharge electrodes 11 such that the preliminary ionization discharge and the main discharge can occur in an appropriate manner.

Accordingly, the high-voltage pulse generator 5 of the eighth embodiment can control the pulse energy of the output pulse laser light still more accurately in comparison with the high-voltage pulse generator 5 of the first embodiment.

In addition, the high-voltage pulse generator 5 of the eighth embodiment can constitute the “n” switches SW1 to SWn of such a combination of semiconductor switches that is optimum for causing the main discharge and the preliminary ionization discharge.

Thereby, the high-voltage pulse generator 5 of the eighth embodiment can configure the pulse power module 50 including the “n” switches SW1 to SWn with requisite minimum components in comparison with the high-voltage pulse generator 5 of the first embodiment.

Therefore, the high-voltage pulse generator 5 of the eighth embodiment can further improve the oscillation efficiency of the pulse laser light with a compact device configuration in comparison with the high-voltage pulse generator 5 of the first embodiment.

### 12.4 Modification 1 of Eighth Embodiment

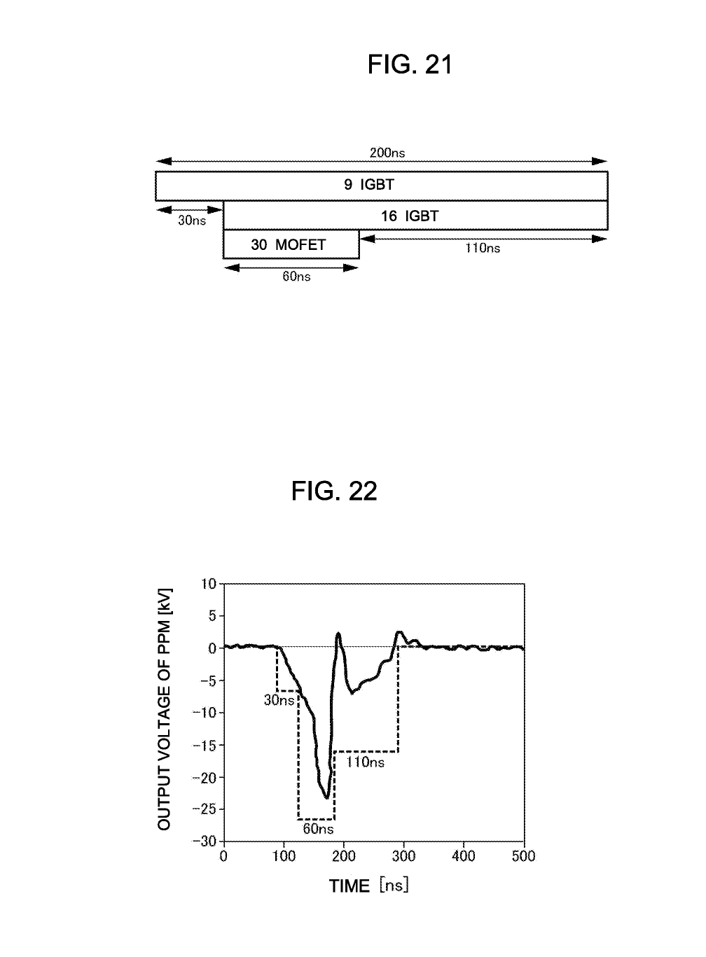

Using FIG. 21 and FIG. 22, a high-voltage pulse generator 5 of modification 1 of the eighth embodiment will be described.

The high-voltage pulse generator 5 of modification 1 of the eighth embodiment may have a configuration which eliminates the peaking capacitor Cp from the configuration of the high-voltage pulse generator 5 of the eighth embodiment. Furthermore, in the high-voltage pulse generator 5 of modification 1 of the eighth embodiment, timing data input to a switch driver section 60 may have different contents from those in the high-voltage pulse generator 5 of the eighth embodiment.

Concerning a gas laser apparatus 1 provided with the high-voltage pulse generator 5 of modification 1 of the eighth embodiment, the description of the same features and operations as those of the gas laser apparatus 1 having the high-voltage pulse generator 5 of the eighth embodiment will be omitted.

FIG. 21 is a diagram illustrating the timing data input to the switch driver section 60 involved in modification 1 of the eighth embodiment in an example of a combination of two or more kinds of semiconductor switches constituting the “n” switches SW1 to SWn and the drive timing therefor.

In the example of FIG. 21, the combination of semiconductor switches constituting the “n” switches SW1 to SWn may be identical to the combination of semiconductor switches involved in the eighth embodiment shown in FIG. 19.

Meanwhile, in the example of FIG. 21, the drive timing for the “n” switches SW1 to SWn may be different from the drive timing for the “n” switches SW1 to SWn involved in the eighth embodiment shown in FIG. 19. Specifically, in the example of FIG. 21, the nine switches SW1 to SW9 composed of IGBTs are driven first, and in 30 ns after the start of driving the switches SW1 to SW9, the 16 switches SW10 to SW25 composed of IGBTs and the 30 switches SW26 to SW56 composed of MOSFETs start being driven. In addition, in the example of FIG. 21, the switches SW26 to SW56 is deactivated in 60 ns after the start of driving the switches SW10 to SW25 and the switches SW26 to SW56, and the switches SW1 to SW9 and the switches SW10 to SW25G are deactivated in 110 ns after the deactivation of the switches SW26 to SW56.

FIG. 22 is a diagram illustrating the output voltage from the pulse power module 50 involved in modification 1 of the eighth embodiment, with the combination of semiconductor switches and the drive timing for the “n” switches SW1 to SWn, as shown in FIG. 21.

A solid line in FIG. 22 shows a waveform of a voltage actually measured as the output voltage from the pulse power module 50. A dashed line in FIG. 22 shows a target voltage in controlling the output voltage from the pulse power module 50, the target voltage corresponding to the combination of semiconductor switches and the drive timing shown in FIG. 21.

Like the switch driver section 60 involved in the eighth embodiment, the switch driver section 60 involved in modification 1 of the eighth embodiment may drive the IGBTs and MOSFETs constituting the “n” switches SW1 to SWn on the basis of the timing data shown in FIG. 21.

Other features and operation in the high-voltage pulse generator 5 of modification 1 of the eighth embodiment may be the same as those of the high-voltage pulse generator 5 of the eighth embodiment.

According to the configuration above, the high-voltage pulse generator 5 of modification 1 of the eighth embodiment can apply a high voltage in a form of a pulse as shown in FIG. 22, which is necessary for the main discharge, across the pair of discharge electrodes 11 without the peaking capacitor Cp. In addition, the high-voltage pulse generator 5 of modification 1 of the eighth embodiment can continue the main discharge occurring across the pair of discharge electrodes 11 for a length for suitably exciting the laser gas, as shown in FIG. 22.

Thus, as compared to the high-voltage pulse generator 5 of the first embodiment, the high-voltage pulse generator 5 of modification 1 of the eighth embodiment can further improve the oscillation efficiency of the pulse laser light with a compact device configuration, like the high-voltage pulse generator 5 of the eighth embodiment.

### 12.5 Modification 2 of Eighth Embodiment

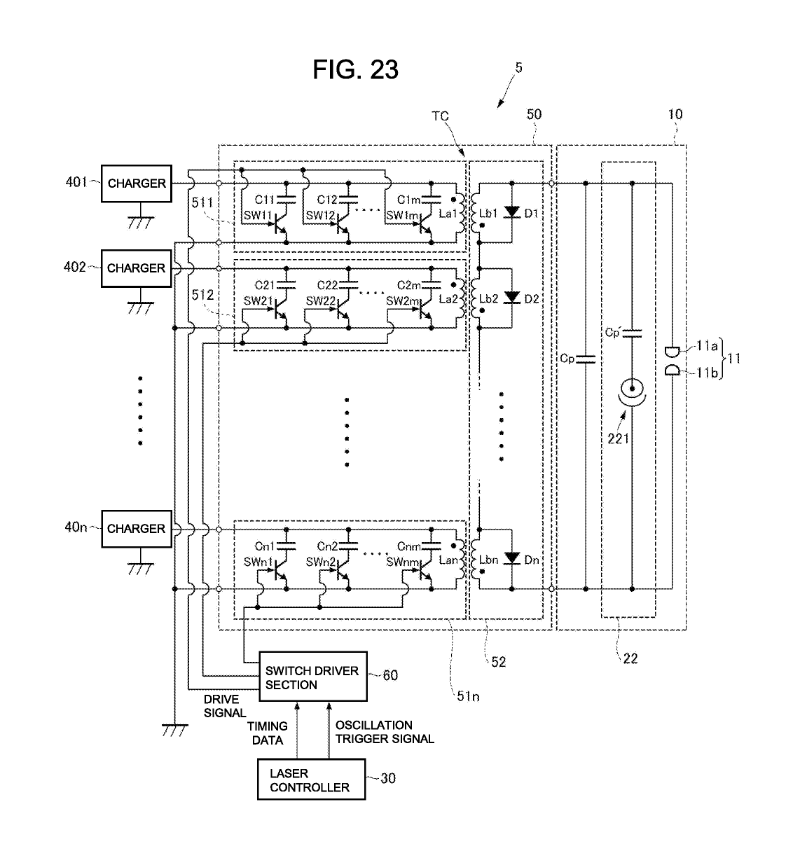

Referring to FIG. 23, a high-voltage pulse generator 5 of modification 2 of the eighth embodiment will be described.

FIG. 23 is a diagram illustrating a configuration of the high-voltage pulse generator 5 of modification 2 of the eighth embodiment.

In the high-voltage pulse generator 5 of modification 2 of the eighth embodiment, each of the “n” primary electric circuits 511 to 51n involved in the eighth embodiment may include multiple capacitors and multiple switches SW, like the “n” primary electric circuits 511 to 51n involved the fifth embodiment.

In other words, the high-voltage pulse generator 5 of modification 2 of the eighth embodiment may be configured by applying the “n” switches SW1 to SWn and the timing data involved in the eighth embodiment to the “n” primary electric circuits 511 to 51n involved in the fifth embodiment. Here, the “m” switches SW included in each of the “n” primary electric circuits 511 to 51n may be constituted of the same kind of semiconductor switches.

In other words, in the high-voltage pulse generator 5 of modification 2 of the eighth embodiment, a number “n” of switch groups included in the “n” primary electric circuits 511 to 51n of the respective stages may be composed of two or more kinds of semiconductor switch groups. However, the “m” switches SW included in each of the “n” switch groups may be composed of the same kind of semiconductor switches.

For example, the “m” switches SW11 to SW1m included in the first stage primary electric circuit 511 that is on the top side in FIG. 23, may be composed of the same kind of semiconductor switches. As a concrete example, each of the “m” switches SW11 to SW1m included in the first stage primary electric circuit 511 on the top side in FIG. 23 may be constituted of IGBT.

For example, the “m” switches SWn1 to SWnm included in the primary electric circuit 51n in the n-th stage in FIG. 23 may be composed of the same kind of semiconductor switches. As a concrete example, each of the “m” switches SWn1 to SWnm included in the primary electric circuit 51n in the n-th stage in FIG. 23 may be constituted of MOSFET.

A switch driver section 60 involved in modification 2 of the eighth embodiment may control driving each of the “m” switches SW included in one switch group at approximately the same drive timing, like the switch driver section 60 involved in the fifth embodiment.

Furthermore, the switch driver section 60 involved in modification 2 of the eighth embodiment may drive each of the “n” switch groups on the basis of the timing data as shown for example in FIG. 19.

Other features and operations of the high-voltage pulse generator 5 of modification 2 of the eighth embodiment may be the same as those of the high-voltage pulse generator 5 of the fifth or the eighth embodiment.

In comparison with the high-voltage pulse generator 5 of the first embodiment, the high-voltage pulse generator 5 of modification 2 of the eighth embodiment, configured as above, can further improve the oscillation efficiency for the pulse lase light with a compact device structure, like the high-voltage pulse generator 5 of the eighth embodiment.

Note that the high-voltage pulse generator 5 of modification 2 of the eighth embodiment may also be provided with a configuration wherein the peaking capacitor Cp is eliminated and the timing data as shown for example in FIG. 21 is provided, like the high-voltage pulse generator 5 of modification 1 of the eighth embodiment.

In addition, the high-voltage pulse generator 5 of modification 2 of the eighth embodiment may be configured by applying the “n” switches SW1 to SWn and the timing data involved in the eighth embodiment to the primary electric circuits involved in the third, the fourth, the sixth or the seventh embodiment.

### 13. Others

### 13.1 Hardware Environment of Each Controller

It would be appreciated for a person skilled in the art that the subject mentioned here can be implemented by a combination of a universal computer or a programmable controller with a program module or a software application. Generally, the program module includes routine programs, components, data structures and the like, which enable executing the processes described in the present disclosure.

FIG. 24 is a block diagram illustrating an example of hardware environment which enables implementation of various aspects of the disclosed subject. The example of hardware environment 100 shown in FIG. 24 may include a processor unit 1000, a storage unit 1005, a user interface 1010, a parallel I/O controller 1020, a serial I/O controller 1030 and an AD/DA converter 1040, but the hardware environment 100 is not limited to this configuration.

The processor unit 1000 may include a central processing unit (CPU) 1001, a memory 1002, a timer 1003, and an image processing unit (GPU) 1004. The memory 1002 may include a random access memory (RAM) and a read-only memory (ROM). The CPU 1001 may be any of processors available in the market. A dual microprocessor or any of other multi-processor architectures may serve as the CPU 1001.

The components shown in FIG. 24 may be interconnected with each other so as to carry out the processes described in the present disclosure.

In the operation, the processor unit 1000 may read a program from the storage unit 1005 and execute the same. In addition, the processor unit 1000 may read data together with the program from the storage unit 1005. Furthermore, the processor unit 1000 may write data on the storage unit 1005. The CPU 1001 may execute the program read from the storage unit 1005. The memory 1002 may be a work memory for temporary storage of the program to be executed by the CPU 1001 and data to be used for operation of the CPU 1001. The timer 1003 may measure the time interval and output the result of measurement to the CPU 1001 according to the execution of the program. The GPU 1004 may process image data according to the program read from the storage unit 1005 and output the processing result to the CPU 1001.

A parallel I/O controller 1020 may be connected to parallel I/O devices which are communicable with the processor unit 1000, such as the laser controller 30 which transmits or receives the target pulse energy Et, the oscillation trigger signal and the like to or from the exposure device controller 111, the switch driver section 60, the charger 40, a number “n” of chargers 401 to 40n, a number “n” of chargers 401a to 40na and a number “n” of chargers 401b to 40nb. The parallel I/O controller 1020 may control communication between the processor unit 1000 and these parallel I/O devices. A serial I/O controller 1030 may be connected to serial I/O devices which are communicable with the processor unit 1000, such as the laser controller 30 which transmits or receives various kinds of data signals to or from the exposure device controller 111, the motor 21 and the heat exchanger 17. The serial I/O controller 1030 may control communication between the processor unit 1000 and these serial I/O devices. An AD/DA converter 1040 may be connected through analog ports to analog devices, such as the light sensor 20c. The AD/DA converter 1040 may control communication between the processor unit 1000 and the analog devices, and may perform AD or DA conversion of the communicated contents.

The user interface 1010 may display the progress of the program currently executed by the processor unit 1000 so that the operator can give instructions to the processor unit 1000, such as stopping the program or executing an interruption routine.

The exemplified hardware environment 100 may be applied to one or more of configurations of the exposure device controller 111, the laser controller 30, the switch driver section 60 and the like in the present disclosure. A person skilled in the art will appreciate that these controllers may be embodied in a distributed computing environment, that is, an environment where processor units are linked to each other over a communication network to perform tasks. In the present disclosure, the exposure device controller 111, the laser controller 30, the switch driver section 60 and other components may be interconnected through a communication network, such as the Ethernet and the Internet. In the distributed computing environment, program modules may be stored in both local and remote memory storage devices.

### 13.2 Other Modifications

The gas laser apparatus 1 may use a high reflective mirror as an alternative to the line narrowing module 18. Then, the gas laser apparatus 1 can output as a pulse laser light to the exposure device 110 a natural excitation light without being narrowed.

The gas laser apparatus 1 is not limited to an excimer laser apparatus, but may be a fluorine molecular laser apparatus that uses a laser gas including a fluorine gas as a halogen gas and a buffer gas.

The switch driver section 60 and the laser controller 30 may be configured to be an integral part. In that case, the switch driver section 60 may be integrated in the laser controller 30, or the function of the laser controller 30 for controlling the components of the high-voltage pulse generator 5 may be integrated into the switch driver section 60.

The switch driver section 60 may also be included in the pulse power module 50. In that case, the function of the laser controller 30 for controlling the components of the high-voltage pulse generator 5 may be integrated into the switch driver section 60.

It should be appreciated for a person skilled in the art that the respective features of the above-described embodiments, including the modifications, are applicable to one another.

The foregoing description is intended to be merely illustrative rather than limiting. It should therefore be appreciated for a person skilled in the art that variations may be made in the embodiments of the present disclosure without departing from the scope as defined by the appended claims.

The terms used throughout the specification and the appended claims are to be construed as “open-ended” terms. For example, the term “include” or “included” is to be construed as “including but not limited to”. The term “have” is to be construed as “having but not limited to”. Also, the modifier “one (a/an)” described in the specification and recited in the appended claims is to be construed to mean “at least one” or “one or more”.

What is claimed is:

1. A high-voltage pulse generator configured to apply a high voltage in a form of a pulse across a pair of discharge electrodes disposed in a laser chamber of a gas laser apparatus, the high-voltage pulse generator comprising:
a number “n” (n is a natural number of not less than 2) of primary electric circuits connected in parallel to one another on a primary side of a pulse transformer; and
a secondary electric circuit of the pulse transformer, the secondary electric circuit being connected to the pair of discharge electrodes,
the “n” primary electric circuits including a number “n” of primary coils connected in parallel to one another, a number “n” of capacitors respectively connected in parallel to the “n” primary coils, and a number “n” of switches respectively connected in serial to the “n” capacitors;
the secondary electric circuit including a number “n” of secondary coils connected in series to one another, and a diode preventing a reverse current flowing from the pair of discharge electrodes toward the secondary coils;
the “n” primary electric circuits being connected to a number “n” of chargers configured to charge the “n” capacitors, respectively;
the “n” capacitors being configured to supply the “n” primary coils with a current corresponding to charge voltages charged by the “n” chargers while the “n” switches being driven; and
the diode being constituted of a number “n” of diodes, each of the “n” diodes being connected to opposite ends of each of the “n” secondary coils, respectively.

2. The high-voltage pulse generator as set forth in claim 1, further comprising a peaking capacitor connected in parallel to and between the “n” secondary coils and the pair of discharge electrodes.

3. The high-voltage pulse generator as set forth in claim 2, further comprising a high withstand voltage diode connected in series to and between the peaking capacitor and the pair of discharge electrodes, the high withstand voltage diode preventing the reverse current from flowing through the peaking capacitor.

4. The high-voltage pulse generator as set forth in claim 2, further comprising a magnetic switch connected in series to and between the “n” secondary coils and the peaking capacitor.

5. The high-voltage pulse generator as set forth in claim 1, wherein each of the “n” capacitors is constituted of a number “m” of capacitors (m is a natural number of not less than 2) connected in parallel to one another, and each of the “n” switches is constituted of a number “m” of switches connected in series to the “m” of capacitors, respectively.

6. The high-voltage pulse generator as set forth in claim 5, wherein modules, each of which includes the “n” primary electric circuits and the secondary electric circuit, are connected in parallel to one another.

7. The high-voltage pulse generator as set forth in claim 1, further comprising a switch driver section configured to control driving each of the “n” switches on the basis of timing data determining drive timing for each of the “n” switches.

8. The high-voltage pulse generator as set forth in claim 7, wherein an apply voltage to be applied across the pair of discharge electrodes is previously determined on the basis of a target pulse energy of pulse laser light output from the gas laser apparatus;
the timing data is determined to drive at least a part of the “n” switches at predetermined drive timing according to the apply voltage; and
the switch driver section drives at least the part of the “n” switches at the predetermined drive timing on the basis of the timing data.

9. The high-voltage pulse generator as set forth in claim 8, wherein the timing data is determined such that one part of the “n” switches are driven at first drive timing, and another part of the “n” switches are driven at second drive timing different from the first drive timing according to the pulse waveform of the apply voltage, which varies with time; and
the switch driver section drives, on the basis of the timing data, the one part of the “n” switches at the first drive timing and the other part of the “n” switches at the second drive timing.

10. The high-voltage pulse generator as set forth in claim 8, wherein the “n” chargers charge the “n” capacitors at different charge voltages from each other;
the timing data is determined to drive at least a part of the “n” switches at predetermined drive timing according to a sum of charge voltages respectively charged at least in a part of the “n” capacitors; and
the switch driver section drives, on the basis of the timing data, at least the part of the “n” switches at the predetermined drive timing.

11. A gas laser apparatus comprising the high-voltage pulse generator as set forth in claim 7 and a laser controller configured to output the timing data to the switch driver section.

12. The high-voltage pulse generator as set forth in claim 1, wherein one part of the “n” switches is constituted of first semiconductor switches that operate at a first switching speed, and another part of the “n” switches is constituted of second semiconductor switches that operate at a second switching speed faster than the first switching speed.

13. The high-voltage pulse generator as set forth in claim 12, further comprising:
preliminary ionization electrodes connected in parallel to and between the secondary electric circuit and the pair of discharge electrodes so as to cause preliminary ionization of the laser gas prior to a main discharge that is caused by dielectric breakdown of the laser gas between the pair of discharge electrodes; and
a switch driver section configured to control driving each of the “n” switches on the basis of timing data determining drive timing for each of the “n” switches, wherein
the timing data is determined such that at least the first semiconductor switches are driven at drive timing corresponding to the timing of occurrence of the preliminary ionization, and that at least the second semiconductor switches are driven at drive timing corresponding to the timing of occurrence of the main discharge; and
the switch driver section is configured to drive the first and second semiconductor switches according to the corresponding drive timing determined by the timing data.

14. A high-voltage pulse generator configured to apply a high voltage in a form of a pulse across a pair of discharge electrodes disposed in a laser chamber of a gas laser apparatus, the high-voltage pulse generator comprising:
a number “n” (n is a natural number of not less than 2) of primary electric circuits connected in parallel to one another on a primary side of a pulse transformer;
a secondary electric circuit of the pulse transformer, the secondary electric circuit being connected to the pair of discharge electrodes; and
a switch driver section,
the “n” primary electric circuits including a number “n” of primary coils connected in parallel to one another, a number “n” of capacitors respectively connected in parallel to the “n” primary coils, and a number “n” of switches respectively connected in serial to the “n” capacitors;
the secondary electric circuit including a number “n” of secondary coils connected in series to one another, and a diode preventing a reverse current flowing from the pair of discharge electrodes toward the secondary coils; and
the switch driver section being configured to control driving each of the “n” switches on the basis of timing data determining drive timing for each of the “n” switches.

15. The high-voltage pulse generator as set forth in claim 14, wherein one part of the “n” switches is constituted of first semiconductor switches that operate at a first switching speed, and another part of the “n” switches is constituted of second semiconductor switches that operate at a second switching speed faster than the first switching speed.

16. The high-voltage pulse generator as set forth in claim 15, further comprising preliminary ionization electrodes connected in parallel to and between the secondary electric circuit and the pair of discharge electrodes so as to cause preliminary ionization of the laser gas prior to a main discharge that is caused by dielectric breakdown of the laser gas between the pair of discharge electrodes, wherein
the timing data is determined such that at least the first semiconductor switches are driven at drive timing corresponding to the timing of occurrence of the preliminary ionization, and that at least the second semiconductor switches are driven at drive timing corresponding to the timing of occurrence of the main discharge; and
the switch driver section is configured to drive the first and second semiconductor switches according to the corresponding drive timing determined by the timing data.
